(19) United States
(12) Patent Application Publication
(10) Pub. No.: US 2026/0241576 A1
(43) Pub. Date: Aug. 20, 2026

(54) ROBOTIC ARM SHOOTING CONTROL SYSTEM, CONTROL METHOD THEREOF, AND COMPUTER-READABLE STORAGE MEDIUM

(71) Applicant: MARVEL TECHNOLOGY(CHINA) CO.,LTD, SHENZHEN (CN)

(72) Inventors: HUAWEI HOU, SHENZHEN (CN); SHENGGUANG LUO, SHENZHEN (CN)

(21) Appl. No.: 19/540,875

(22) Filed: Feb. 16, 2026

(30) Foreign Application Priority Data
Feb. 17, 2025 (CN) 202510170976.1

(51) Int. Cl. B25J 9/16; B25J 13/06; H04N 23/62; H04N 23/67; H04N 23/69

(52) U.S. Cl. CPC B25J 9/1697; B25J 9/1664; B25J 13/06; H04N 23/62; H04N 23/67; H04N 23/69

(57) ABSTRACT

A robotic arm shooting control system, control method thereof, and a computer-readable storage medium are provided. The robotic arm shooting control system includes a host machine, a shooting device, a control module, and a robotic arm. The control module is configured to communicate with the host machine, control an operation of the robotic arm according to a robotic arm control instruction, and control an operation of the shooting device according to shooting device control instructions. The robotic arm is communicated with the control module, and the robotic arm is configured to mount the shooting device and drive the shooting device to move along a motion trajectory of the robotic arm according to the robotic arm control instruction. The motion trajectory of the robotic arm is preset.

### TECHNICAL FIELD

The present disclosure relates to a field of photography technology, and in particular to a robotic arm shooting control system, control method thereof, and a computer-readable storage medium.

### BACKGROUND

With the increasing demand for film and television production and industrial shooting, robotic arms are widely used in shooting scenes to achieve complex motion trajectories of cameras. However, conventional robotic arm shooting systems have certain limitations in synchronously controlling a motion of a robotic arm and a focus and a zoom of a shooting device. Generally, the robotic arm moves according to a preset motion trajectory, but focus and zoom parameters of the shooting device need to be manually adjusted, or fixed focus and zoom parameters are only allowed to be set before the motion starts, which are unable to meet requirements for real-time adjustment of the focus and the zoom of the shooting device during a shooting process. As a result, occasions such as blurred images, inaccurate focus, or poor composition may occur, which affect a shooting effect.

### SUMMARY

A purpose of the present disclosure is to provide a robotic arm shooting control system, a control method thereof, and a computer-readable storage medium to address shortcomings in the prior art. The present disclosure provides the robotic arm shooting control system that is able to dynamically adjust target focus and zoom parameters of a shooting device in real time during a motion of the robotic arm, so as to ensure clarity and image quality of captured images and achieve synchronous control of the motion of the robotic arm and an adjustment of the target focus and zoom parameters of the shooting device.

The robotic arm shooting control system comprises a host machine, a shooting device, a control module, and a robotic arm.

The control module is configured to communicate with the host machine, control an operation of the robotic arm according to a robotic arm control instruction, and control an operation of the shooting device according to shooting device control instructions. The control module comprises a control board circuit. The control board circuit comprises a central processing unit (CPU), a communication module, a BLUETOOTH module, an Ethernet module, a WIFI module, a memory, a power supply module, etc. An executable program is installed on the control module for receiving instructions from the host machine and issuing control instructions to the robotic arm and the shooting device.

The robotic arm is communicated with the control module. The robotic arm is configured to mount the shooting device and drive the shooting device to move along a motion trajectory of the robotic arm according to the robotic arm control instruction. The motion trajectory of the robotic arm is preset. The robotic arm further comprises an internal controller and a control system; a control box of the robotic arm is connected to an external device via an IO, and is connected to the control module via a network cable or WIFI to receive the robotic arm control instruction from the control module.

The robotic arm shooting control system comprises the host machine; the control module; the robotic arm; and the shooting device.

The host machine is configured to preset the motion trajectory of the robotic arm, to generate the robotic arm control instruction based on the motion trajectory of the robotic arm, to preset first focus and zoom parameters of the shooting device at motion nodes of the robotic arm, and to generate the shooting device control instructions based on the target focus and zoom parameters at the motion nodes.

The control module is configured to communicate with the host machine, control the operation of the robotic arm according to the robotic arm control instruction, and control the operation of the shooting device according to the shooting device control instructions. The robotic arm is communicated with the control module. The robotic arm is configured to mount the shooting device and drive the shooting device to move along the motion trajectory of the robotic arm according to the robotic arm control instruction.

The shooting device is installed on the robotic arm and is communicated with the control module. The shooting device is configured to dynamically adjust focus and zoom thereof during a motion of the robotic arm to capture images.

In one embodiment, the control module is further configured to acquire motion trajectory information and a motion time of the robotic arm and perform following operations based on the motion trajectory information and the motion time of the robotic arm:

when a current position of the robotic arm is located at a designated motion node or a designated time node, selecting the first focus and zoom parameters corresponding to the designated motion node; and when the current position of the robotic arm is located between two adjacent motion nodes, calculating second focus and zoom parameters corresponding to the current position between the two adjacent motion nodes.

The second focus and zoom parameters are between the first focus and zoom parameters corresponding to the two adjacent motion nodes. The focus and the zoom of the shooting device are dynamically adjusted during the motion of the robotic arm to ensure continuity and smoothness of the captured images.

In one embodiment, the robotic arm shooting control system further comprises a server communicated with the host machine. The server is configured to store the motion trajectory and first focus and zoom parameters preset by the host machine.

In one embodiment, the host machine of the robotic arm shooting control system may be a smart mobile device or a desktop device. An executable computer program is installed on the host machine for sending the control instructions and data to the robotic arm and the shooting device. After shooting is completed, the host machine further downloads captured video content to perform video processing. The video content is processed into different video modes according to preset processing schemes, such as various processing schemes including high frame rate slow motion, video fast forwarding, and video reverse playback.

In one embodiment, the shooting device of the robotic arm shooting control system is a camera of the smart mobile device, and therefore, the shooting device itself at this time serves as the host machine.

The robotic arm further comprises a position feedback device and a distance detection device. The position feedback device is configured to feed back a current position of the robotic arm to the control module. The distance detection device is configured to detect a distance between the shooting device and a shooting target. The distance between the shooting device and the shooting target is calculated in multiple methods. A first method is adopted under a condition that a position of the shooting target is determined before shooting and is static, the distance of the shooting target from the shooting device is a sum of a static distance and a dynamic distance of the shooting device on the robotic arm. At this time, the distance is calculated without the position feedback device. A second method is to calculate via a distance feedback device, where the dynamic distance of the shooting target is acquired through a ranging sensor installed on the shooting device. A third method is to acquire the dynamic distance of the shooting target through a visual algorithm.

In one embodiment, the host machine comprises a user interface. A user is able to preset the motion trajectory of the robotic arm and first focus and zoom parameters of the shooting device at motion nodes of the robotic arm. The user interface further comprises shooting control buttons, a robotic arm trajectory selection interface, voice prompts, video processing, and work sharing interfaces.

In one embodiment, the robotic arm control instruction is configured to control at least one of a start, a stop, a trajectory planning, and a speed adjustment of the robotic arm;

The shooting device control instructions are configured for connecting, detecting, starting, stopping, and recording the shooting device. The shooting device control instructions are further configured to dynamically adjust the focus and the zoom of the shooting device during the motion of the robotic arm according to the first focus and zoom parameters and/or the second focus and zoom parameters corresponding to the current position of the robotic arm. The shooting device control instructions are able to control the operation of the camera of the shooting device and download the captured images after shooting is completed.

When the robotic arm moves linearly between the two adjacent motion nodes, target focus and zoom parameters of the shooting device are adjusted step by step at time intervals by calculating a difference between the first focus and zoom parameters of the two adjacent motion nodes.

When the robotic arm moves non-linearly between the two adjacent motion nodes, a distance measurement interpolation method is adopted to dynamically adjust the target focus and zoom parameters of the shooting device by calculating a distance between the current position of the robotic arm and a shooting target and performing interpolation based on a distance difference.

Specifically, the control module is communicated with the robotic arm and the shooting device through wireless communication and/or wired communication.

Specifically, the control module is communicated with the robotic arm and the shooting device to realize position feedback. The position feedback is configured to monitor the current position and a posture of the robotic arm in real time, so that the control module is able to know a current motion node of the robotic arm or whether the robotic arm is located between the two adjacent motion nodes. During an implementation process, a trajectory of the robotic arm is pre-planned. The trajectory of the robotic arm comprises the motion trajectory and a speed. Based on the motion trajectory and the speed of the robotic arm, the position of the shooting device installed at one end of the robotic arm at a certain moment is calculated. The position feedback device provides internal position data of the robotic arm, such as joint angles and spatial coordinates, which are configured to accurately calculate the current position of the end of the robotic arm (i.e., the position of the shooting device). The position feedback is mainly configured to determine the position of the robotic arm to achieve preset trajectory and position control. For example, it helps the control module to determine whether the robotic arm arrives at the designated motion node or is located between the two adjacent motion nodes, so as to decide whether to apply the first focus and zoom parameters or an interpolation algorithm.

A distance detection device in the present disclosure is the ranging sensor. The ranging sensor is configured to detect an actual distance between the one end of the robotic arm (i.e., the position of the shooting device) and the shooting target, helping to preset or verify the first focus and zoom parameters to ensure clear imaging of the shooting target. The ranging sensor is a laser rangefinder, an ultrasonic sensor, etc., which is installed on the shooting device or the one end of the robotic arm for measuring the actual distance from the end of the robotic arm to the shooting target. The ranging sensor provides distance information from the shooting device to the shooting target, which is independent of the internal position data of the robotic arm. The distance information is configured to determine optimal focus and zoom parameters of the shooting device. The ranging sensor is mainly configured to preset or verify the first focus and zoom parameters. The ranging sensor helps the control module to set appropriate focus and zoom parameters according to different distances during a presetting stage, so as to ensure that the shooting target is always within a clear focus range.

In one embodiment, the robotic arm shooting control system further comprises an artificial intelligence (AI) automatic focusing and zooming module based on an AI distance measurement module. The AI automatic focusing and zooming module is configured to calculate a distance to a shooting target based on images captured by the shooting device to assist in adjusting target focus and zoom parameters of the shooting device before the robotic arm starts shooting. The AI automatic focusing and zooming module comprises an image acquisition unit, an image preprocessing unit, a feature extraction unit, a distance calculation unit, and a parameter adjustment unit.

The image acquisition unit is configured to acquire an image of the shooting target before the robotic arm starts shooting. The image preprocessing unit is configured to perform denoising and enhancement processing on the image of the shooting target. The feature extraction unit is configured to extract at least one of an edge feature, a shape feature, and a color feature of the shooting target from a preprocessed image. The distance calculation unit is configured to calculate a distance between the shooting target and a camera of the shooting device based on a size of the shooting target, position information in the preprocessed image, a focal length and a sensor size of the camera; and at least one of the edge feature, the shape feature, and the color feature of the shooting target. The parameter adjustment unit is configured to preset the first focus and zoom parameters for the shooting device at each of the motion nodes of the robotic arm according to the distance calculated by the distance calculation unit during the presetting stage, so as to ensure optimal imaging at each of the motion nodes during the shooting process. For example, in the motion trajectory of the robotic arm, when the shooting target is 3 meters from a starting position of the robotic arm, then the distance between the starting position and an ending position of the robotic arm is 3 meters minus a straight-line distance traveled by the shooting device after the motion of the robotic arm.

The robotic arm shooting control system further comprises a quick-response (QR) code. The QR code contains a remote control server address of the robotic arm; when a user scans the QR code by a smart terminal device. The smart terminal device automatically jumps to a remote control user interface. The motion trajectory of the robotic arm and/or a shooting mode of the shooting device are selectable via the remote control user interface. When the smart terminal device sends control instructions to the robotic arm and the shooting device, the robotic arm moves according to the motion trajectory, and the shooting device captures the images according to a designated motion trajectory, so that the smart terminal device has a capability of remote control of the robotic arm shooting. The QR code is further configured as a sharing QR code. The user enters an email address or a mobile phone number in the remote control user interface, and once the robotic arm finishes shooting, shooting works are automatically sent to the email address or a mobile phone with the mobile phone number designated by the user, so that the robotic arm shooting control system has a capability of automatic sharing.

In one embodiment, different video processing modes and video playback speeds are preset at different motion nodes or time nodes according to the preset motion trajectory of the robotic arm. For example, performing fast forwarding at a first motion node, performing slow forwarding at a second motion node, and performing reverse playback at a third motion node, or performing other various video processing modes, so that videos captured by the shooting device along the same motion trajectory of the robotic arm have diverse presentation styles, thereby enriching artistic appeal of works.

The present disclosure further provides a robotic arm shooting control method. The robotic arm shooting control method comprises following steps:
a presetting step: presetting a motion trajectory of a robotic arm and first focus and zoom parameters of motion nodes of the robotic arm, and storing the motion trajectory and the first focus and zoom parameters in a server for a control module to invoke;
a first control step: sending, by a host machine, a robotic arm control instruction generated based on the motion trajectory of the robotic arm to the control module, controlling, by the control module, the robotic arm to move according to the motion trajectory;
a dynamic pre-adjustment step: receiving, by the control module, position information of the robotic arm in real time, and obtaining target focus and zoom parameters corresponding to a current position of the robotic arm;
a second control step: generating, by the control module, a focus and zoom instruction based on the target focus and zoom parameters obtained in the dynamic pre-adjustment step, and sending the focus and zoom instruction to a shooting device; and
an image acquisition step: dynamically adjusting a focus position and a zoom magnification of a lens, by the shooting device, based on the first focus and zoom parameters according to the focus and zoom instruction to perform image acquisition.

The image acquisition step ensures clear images, smooth adjustments, and smooth transitions, avoiding image discontinuity issues caused by sudden parameter changes.

In one embodiment, the dynamic pre-adjustment step comprises:
receiving, by the control module, the position information of the robotic arm in real time, and when a current position of the robotic arm is located on one of the motion nodes, selecting the first focus and zoom parameters corresponding to the one of the motion nodes; when the current position of the robotic arm is located between two adjacent motion nodes, calculating second focus and zoom parameters corresponding to the current position via an interpolation algorithm.

The second focus and zoom parameters are between the first focus and zoom parameters of the two adjacent motion nodes. The second control step comprises generating, by the control module, a focus and zoom instruction based on the first focus and zoom parameters or the focus and zoom parameters obtained from the dynamic pre-adjustment step, and sending the focus and zoom instruction to the shooting device.

In one embodiment, in the dynamic pre-adjustment step, when the robotic arm performs a linear motion between the two adjacent motion nodes. The interpolation algorithm adopts a linear interpolation method to calculate a focus parameter corresponding to the current position by a formula (1) and a zoom parameter corresponding to the current position, and dynamically adjusts the second focus and zoom parameters corresponding to the current position of the shooting device.

The formula (1) is as follows:

$$v = a + \frac{b - a}{t} \times {t}_{current} .$$

In the formula (1), v represents the focus parameter at a current moment. a represents a first focus parameter of a starting motion node A of the two adjacent motion nodes; b represents a first focus parameter of an end motion node B. t represents a total time required for the robotic arm to move from the starting motion node A to the end motion node B. t_{current} represents a time period since the robotic arm started from the starting motion node A, that is, a time difference between the current moment and a starting time.

When the robotic arm performs a non-linear motion between the two adjacent motion nodes, the interpolation algorithm adopts a distance-measurement interpolation method, comprising following steps:
dividing a path between the two adjacent motion nodes into n division points according to a motion trajectory distance of the robotic arm;
for each of the division points, calculating a distance x between each of the division points and the shooting target;
calculating a current focus parameter v=f(x) based on each distance x and a preset distance-to-focus relationship function f(x);
calculating a current zoom parameter based on each distance x and a preset distance-to-zoom relationship function g(x); and
dynamically adjusting the second focus and zoom parameters v and g(x) of the shooting device.

Specifically, the control module is communicated with the robotic arm and the shooting device through wireless communication and/or wired communication, by standard communication protocols to achieve reliable data transmission.

In one embodiment, the control module comprises a user interface for a user to input the first focus and zoom parameters, preview a shooting screen in real time, and perform parameter adjustment during a shooting process. After the image acquisition step, the robotic arm shooting control method further comprises:
a first real-time feedback fine-tuning step: receiving in real time, by the control module, a real-time distance between the current position of the robotic arm and the shooting target fed back by a distance detecting device installed on the robotic arm; when a discrepancy is found between real-time distance data and a preset distance corresponding to the target focus and zoom parameters obtained in the dynamic pre-adjustment step, fine-tuning, by the control module, the target focus and zoom parameters of the shooting device according to the real-time distance data; and a second real-time feedback fine-tuning step: during a continuous motion of the robotic arm, an AI distance measurement module periodically acquires images from the shooting device, and performs preprocessing and feature extraction on the images; calculating the real-time distance between the shooting target and the shooting device based on image features and camera parameters of the shooting device; comparing, by the control module, the real-time distance with the preset distance corresponding to the target focus and zoom parameters obtained in the dynamic pre-adjustment step, and when the discrepancy is found, fine-tuning the target focus and zoom parameters of the shooting device.

The AI distance measurement module comprises an image acquisition unit, an image preprocessing unit, a feature extraction unit, and a distance calculation unit. The image acquisition unit is configured to periodically acquire the images of the shooting target during the motion of the robotic arm. The image preprocessing unit is configured to perform denoising and enhancement processing on the images. The feature extraction unit is configured to extract at least one of an edge feature, a shape feature, and a color feature of the shooting target from preprocessed images. The distance calculation unit is configured to calculate the real-time distance between the shooting target and the shooting device based on a size of the shooting target, position information in the preprocessed image, a focal length and a sensor size of the camera; and at least one of the edge feature, the shape feature, and the color feature of the shooting target.

The present disclosure further provides a computer-readable storage medium. The computer-readable storage medium comprises a computer program stored thereon. When the computer program is executed, the robotic arm shooting control method described above.

In the present disclosure, the robotic arm control instruction and the shooting device control instructions are generated by presetting the motion trajectory of the robotic arm and the first focus and zoom parameters of the shooting device at the motion nodes in the host machine. After receiving the robotic arm control instruction and the shooting device control instructions, the control module controls the operation of the robotic arm and the operation of the shooting device. The robotic arm moves according to the motion trajectory, and the shooting device dynamically adjusts the target focus and zoom parameters during the motion of the robotic arm according to the shooting device control instructions.

The present disclosure achieves synchronous control and improves shooting quality. By presetting the motion trajectory of the robotic arm and the first focus and zoom parameters in the host machine, the robotic arm shooting control system is able to dynamically adjust the focus and the zoom of the shooting device while the robotic arm is moving, thereby achieving synchronous control of the motion of the robotic arm and an adjustment of parameters of the shooting device, and ensuring clarity and stability of the captured images.

The present disclosure improves work efficiency and simplifies operation processes. By adopting a mode of presetting the first focus and zoom parameters and automatic control, a demand for manual intervention is reduced, tedious steps of manually adjusting the parameters of the shooting device during the shooting process are avoided, and overall work efficiency is improved.

The present disclosure enhances flexibility and adaptability of the robotic arm shooting control system. By presetting the first focus and zoom parameters at the motion nodes and dynamically adjusting the target focus and zoom parameters during the motion of the robotic arm, the robotic arm shooting control system is able to adapt to complex shooting scenes and variable shooting requirements, meeting different shooting effect requirements.

The present disclosure avoids degradation of image quality and ensures continuity. By dynamically adjusting the target focus and zoom parameters, image blur or discontinuity caused by inaccurate focus or sudden zoom changes is avoided, and overall quality of a film is improved.

### BRIEF DESCRIPTION OF DRAWINGS

FIG. is a schematic diagram of a robotic arm shooting control system according to one embodiment of the present disclosure.

FIG. 2 is a schematic diagram of a robotic arm shooting control method according to one embodiment of the present disclosure.

FIG. 3 is another schematic diagram of the robotic arm shooting control system according to one embodiment of the present disclosure.

FIG. 4 is a schematic diagram of a robotic arm according to one embodiment of the present disclosure.

FIG. 5 is another schematic diagram of the robotic arm according to one embodiment of the present disclosure.

FIG. 6 is a schematic diagram of bottom support plates, shown in an unfolded state, of the robotic arm according to one embodiment of the present disclosure.

FIG. 7 is a schematic diagram of the bottom support plates, shown in a folded state, of the robotic arm according to one embodiment of the present disclosure.

FIG. 8 is another schematic diagram of the robotic arm according to one embodiment of the present disclosure.

FIG. 9 is another schematic diagram of the robotic arm according to one embodiment of the present disclosure.

The patent or application file contains at least one drawing executed in color, which is for illustrative purposes only and forms no part thereof.

### DETAILED DESCRIPTION

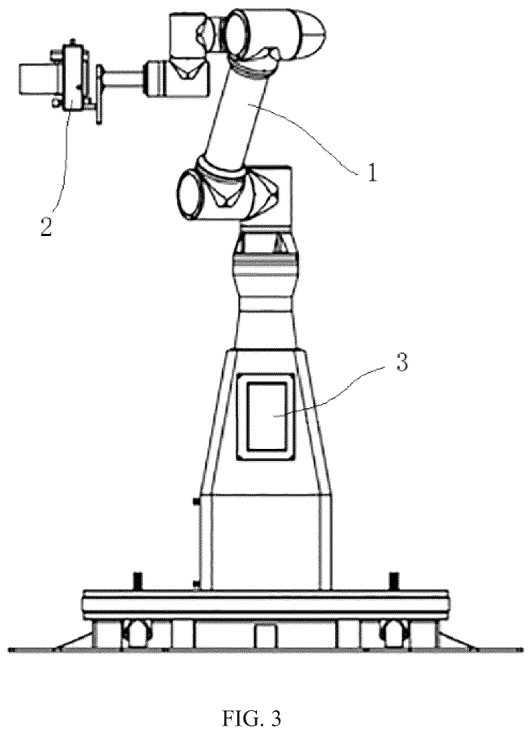

As shown in FIGS. 1-3, the robotic arm shooting control system comprises a control module and a robotic arm. Alternatively, the robotic arm shooting control system comprises a server, a host machine, a shooting device, the control module, and the robotic arm.

The host machine is configured to preset a motion trajectory of the robotic arm, to generate a robotic arm control instruction based on the motion trajectory of the robotic arm, to preset first focus and zoom parameters of the shooting device at motion nodes of the robotic arm, and to generate the shooting device control instructions based on the target focus and zoom parameters at the motion nodes. The first focus and zoom parameters, the robotic arm control instruction, and the shooting device control instructions are able to be set through a user interface and are stored in the server to be called by the control module. Specifically, the first focus and zoom parameters of the shooting device are preset at motion nodes of the robotic arm based on the motion trajectory of the robotic arm. The first focus and zoom parameters, the robotic arm control instruction, and the shooting device control instructions are stored in the server for the control module to invoke. The host machine comprises the user interface, and a user is able to preset the motion trajectory of the robotic arm and preset the first focus and zoom parameters of the shooting device at each of the motion nodes through the user interface. The user interface further allows the user to preview camera images in real time and fine-tune the first focus and zoom parameters to ensure accuracy of parameter settings.

The control module 3 is configured to communicate with the host machine, control an operation of the robotic arm according to the robotic arm control instruction, and control an operation of the shooting device according to the shooting device control instructions. The control module 3 further receives position information of the robotic arm in real time, and selects appropriate focus and zoom parameters according to a current position of the robotic arm. When the robotic arm is located at one of the motion nodes, the first focus and zoom parameters corresponding to the one of the motion nodes are directly selected. When the robotic arm is located between two adjacent motion nodes, second focus and zoom parameters corresponding to the current position are calculated through an interpolation algorithm. Specifically, the control module comprises a wireless receiving module, a BLUETOOTH communication module, a wireless WIFI module, and an RJ45 interface. The control module supports BLUETOOTH communication, WIFI communication, Ethernet communication, serial communication, etc. The control module further comprises a voice module capable of performing voice recognition, which facilitates receiving voice instructions to achieve voice-controlled operations. The control module comprises a central processing unit and is a programmable system.

The robotic arm 1 is communicated with the control module, and drives the shooting device to move along the motion trajectory according to the robotic arm control instruction. The robotic arm comprises a driving module, and the driving module is connected to the control module via a network cable or WIFI to receive the robotic arm control instruction from the control module. A position feedback device is installed on the robotic arm. The position feedback device is configured to monitor the current position and a posture of the robotic arm in real time and feed back the position information to the control module. A distance detection device configured to detect an actual distance between the shooting device and a shooting target is installed on the robotic arm. The distance detection device is a ranging sensor, such as a laser rangefinder or an ultrasonic sensor, which is installed at one end of the robotic arm and is on a same plane as a camera of the shooting device.

The shooting device 2 is installed on the robotic arm and is communicated with the control module. According to the shooting device control instructions, the shooting device 2 dynamically adjusts the target focus and zoom parameters during the motion of the robotic arm to perform image acquisition. The shooting device is generally an independent video camera, a camera, or a camera on a mobile phone, and has a function of supporting setting of the first focus and zoom parameters through the shooting device control instructions. The shooting device has a built-in BLUETOOTH module and a built-in WIFI module for receiving the shooting device control instructions from the host machine. When the shooting device is the independent video camera, the shooting device receives the shooting device control instructions from the host machine. When the shooting device is the camera of the mobile phone, the mobile phone itself is able to directly control the camera thereof to shoot.

The server is communicated with the host machine. The server is configured to store the motion trajectory and first focus and zoom parameters preset by the host machine. The motion trajectory and first focus and zoom parameters are configured to be invoked by the control module.

The robotic arm shooting control system further comprises a quick-response (QR) code. The QR code contains a remote control server address of the robotic arm; when a user scans the QR code by a smart terminal device. The smart terminal device automatically jumps to a remote control user interface. The motion trajectory of the robotic arm and/or a shooting mode of the shooting device are selectable via the remote control user interface. When the smart terminal device sends control instructions to the robotic arm and the shooting device, the robotic arm moves according to the motion trajectory, and the shooting device captures the images according to a designated motion trajectory, so that the smart terminal device has a capability of remote control of the robotic arm shooting. The QR code is further configured as a sharing QR code. The user enters an email address or a mobile phone number in the remote control user interface, and once the robotic arm finishes shooting, shooting works are automatically sent to the email address or a mobile phone with the mobile phone number designated by the user, so that the robotic arm shooting control system has a capability of automatic sharing.

Furthermore, different video processing modes and video playback speeds are preset at different motion nodes or time nodes according to the preset motion trajectory of the robotic arm. For example, performing fast forwarding at a first motion node, performing slow forwarding at a second motion node, and performing reverse playback at a third motion node, or performing other various video processing modes, so that videos captured by the shooting device along the same motion trajectory of the robotic arm have diverse presentation styles, thereby enriching artistic appeal of works.

The robotic arm shooting control system has a function of controlling the robotic arm. Specifically, the control module is electrically connected with or communicated with the robotic arm, and the control module is configured to send the robotic arm control instruction to the robotic arm to control the robotic arm to move along the motion trajectory. The control module is connected to the robotic arm via Ethernet or WIFI, and sends and receives data using TCP/HTTP protocols. The robotic arm control instruction comprises a start, a stop, a trajectory planning, a speed adjustment, etc., as well as abundant motion control instructions such as joint motion, arc motion, linear motion, and spline curve planning.

The robotic arm shooting control system has a function of controlling the shooting device. Specifically, the shooting device comprises a wireless receiving module for receiving the shooting device control instructions from the host machine, so as to control the camera of the shooting device to perform shooting during the motion of the robotic arm. The camera comprises a BLUETOOTH communication module and a WIFI communication module. The host machine is connected to the camera via the BLUETOOTH communication module and the WIFI communication module to send camera control instructions including the shooting device control instructions. The camera control instructions comprise setting an automatic focus or a manual focus, a zoom magnification (Zoom in or Zoom out), and setting specific zoom parameters and focus parameters. The camera control instructions further comprise adjustment of parameters such as metering, ISO, exposure, aperture, shutter, white balance, sharpness, contrast, saturation, and brightness, as well as camera information acquisition, shutdown or restart of the camera, working mode switching, memory card management, file management, etc.

The robotic arm shooting control system has a function of dynamically adjusting a focus of the camera. Specifically, according to the motion trajectory and a motion time of the robotic arm, distances between the shooting device and the shooting target at the motion nodes of the robotic arm are acquired, and accurate focus parameters are preset at the motion nodes of the robotic arm. During the motion of the robotic arm for shooting, the focus of the camera is dynamically adjusted according to preset focus data to ensure that the captured images always maintain a clear state, thereby avoiding accuracy errors and delay problems caused by automatic focusing. For example, the motion trajectory of the robotic arm passes through a starting motion node A, intermediate motion nodes B and C, and an end motion node D. At a position of each of the motion nodes, a corresponding one of the first focus parameters is preset according to a distance between each of the motion nodes and the shooting target. The camera is able to capture clear images at each of the motion nodes. When the robotic arm moves from the motion node A to the motion node B, the camera dynamically adjusts a current focus parameter to make focus parameters smoothly transition from a first focus parameter of the motion node A to a first focus parameter of the motion node B. Therefore, it is ensured that the focus of the camera during the entire shooting process is always maintained in the clearest state.

The robotic arm shooting control system adopts a smooth focusing and zooming algorithm. In order to achieve a smooth transition of the focus and zoom parameters, the interpolation algorithm is adopted. The interpolation algorithm comprises a linear interpolation method and a distance measurement interpolation method. The linear interpolation method is applicable to a case where the robotic arm performs a linear motion between two adjacent motion nodes.

The linear interpolation method comprises steps S1-S4.

The step S1 comprises determining the first focus parameter a of the motion node A (e.g., a staring motion node in the two adjacent motion nodes) and the first focus parameter b of the motion node B (e.g., an end motion node in the two adjacent motion nodes).

The step S2 comprises calculating a total time tₜₒₜₐₗ and a current moment t_{current}.

The step S3 comprises calculating a current focus parameter by a formula (1).

The formula (1) is as follows:

$$v = a + \frac{b - a}{t} \times {t}_{current} .$$

In the formula (1), v represents the current focus parameter at the current moment. a represents a first focus parameter of the starting motion node A of the two adjacent motion nodes. b represents the first focus parameter of the end motion node B. t represents the total time required for the robotic arm to move from the starting motion node A to the end motion node B. t_{current} represents a time period since the robotic arm started from the starting motion node A, that is, a time difference between the current moment and a starting time.

For example, the first focus parameter of the starting motion node A is a=10. The first focus parameter of the end motion node B is b=20. The total time is t=5 seconds. A total number of focus adjustment steps c=b−a=20−10=10, and an time interval

$$y = \frac{t}{c} = \frac{5}{10} = 0.5 seconds ,$$

when t_{current}=2 seconds, n and v are calculated. The number of instructions sent is

$$n = ⌊ \frac{2}{0.5} ⌋ = 4.$$

The current focus parameter is v=a+n=10+4=14. When t_{current}=5 seconds, (i.e., the robotic arm moves to the end motion node) the number of instructions sent is

$$n = ⌊ \frac{5}{0.5} ⌋ = 10 ,$$

the current focus parameter is v=10+10=20. Namely, the first focus parameter is smoothly adjusted from a=10 to b=20.

The step S4 comprises calculating a current zoom parameter according to a method similar to that of steps S1-S3.

When the robotic arm performs a non-linear motion between the two adjacent motion nodes, the interpolation algorithm adopts a distance-measurement interpolation method. The distance-measurement interpolation method comprises steps S1-S4.

The step S1 comprises dividing a path between the two adjacent motion nodes into n division points according to a motion trajectory distance of the robotic arm.

The step S2 comprises, for each of the division points, calculating a distance x between each of the division points and the shooting target.

The step S3 comprises calculating a current focus parameter v=f(x) based on each distance x and a preset distance-to-focus relationship function f(x).

The step S4 comprises calculating a current zoom parameter according to a method similar to that of steps S1-S3.

The robotic arm shooting control system has an intelligent distance measurement function. A distance detection device, such as an ultrasonic ranging sensor, a laser ranging sensor, an infrared ranging sensor, or a millimeter-wave radar sensor, is installed at the one end of the robotic arm, and an installation position thereof is on the same plane as the camera of the shooting device to measure the distance between the camera and the shooting target. Based on the distance between the camera and the shooting target, the current focus parameter is calculated by determining a relationship between a focal length and a focus distance. Then, a focus instruction is sent through a control interface of the shooting device to maintain a captured image in a clear state. The robotic arm shooting control system has an AI distance measurement function.

Before the robotic arm starts shooting, a frame of image is captured in advance, and the distance between the camera and the shooting target is calculated through computer vision technology and deep learning algorithms. Specific steps comprise steps S1-S4.

The step S1 comprises image acquisition: acquiring an image.

The step S2 comprises image preprocessing: performing processing such as denoising and enhancement on the image.

The step S3 comprises feature extraction: extracting key features such as an edge feature, a shape feature, and a color feature of the shooting target from the image.

The step S4 comprises distance calculation: calculating the distance between the shooting target and the camera based on the dimensions of the shooting target and position information in the image, combined with parameters of the camera (focal length, sensor size).

The robotic arm shooting control system has a dynamic zoom scaling function.

According to the motion trajectory and the motion time of the robotic arm, first zoom parameters are preset at the motion nodes. During a motion shooting of the robotic arm, the camera adjusts the second zoom parameters according to preset zoom data to achieve a zoom-in or zoom-out change of the image.

The user is able to set zooming nodes on a timeline of the operation of the robotic arm, start zooming at a designated time point, and set a corresponding first zoom parameter.

The robotic arm shooting control system achieves smooth zooming. Between two adjacent first zoom parameters that are preset, the second zoom parameters of the camera transition smoothly to ensure smoothness of image scaling.

The robotic arm shooting control system has the user interface. The user interface allows the user to control the robotic arm to pause at any time point, preset the first focus and zoom parameters of a current time point, and preview camera images in real time. The user is able to fine-tune the first focus parameters to ensure clarity of the captured images.

The robotic arm shooting control system has other control modes, such as the BLUETOOTH communication and the WIFI communication: Both the control module and the shooting device support the BLUETOOTH communication and the WIFI communication, and the host machine is able to send control instructions through these modes.

The robotic arm shooting control system is able to be controlled by scanning the QR code. A user is able to establish communication with the robotic arm by scanning the QR code to remotely control the robotic arm and the shooting device, thereby ensuring safety of operators.

The robotic arm shooting control system has a voice control system. The control module comprises a sound receiving module, allowing the user to control the operation of the robotic arm and the operation of the shooting device through voice instructions.

A working principle of the robotic arm shooting control system is as follows.

In the presetting stage, the motion trajectory and the first focus and zoom parameters are preset. Specifically, the user presets the motion trajectory of the robotic arm through the user interface of the host machine, and presets the first focus and zoom parameters of the shooting device at the motion nodes of the robotic arm. The first focus and zoom parameters are stored on the server for the control module to invoke.

During the presetting stage, an AI distance measurement assistance may be provided. Specifically, before the robotic arm starts shooting, the AI automatic focusing and zooming module calculates the distance between the shooting device and the shooting target based on the image captured by the shooting device, assisting in adjusting the first focus and zoom parameters of the shooting device. The AI automatic focusing and zooming module comprises an image acquisition unit, an image preprocessing unit, a feature extraction unit, a distance calculation unit, and a parameter adjustment unit.

A shooting stage comprises a First control step, a dynamic pre-adjustment step, a second control step, and an image acquisition step.

The first control step comprises sending, by the host machine, the robotic arm control instruction generated based on the motion trajectory of the robotic arm to the control module, and controlling, by the control module, the robotic arm to move according to the motion trajectory.

The dynamic pre-adjustment step comprises receiving, by the control module, the position information of the robotic arm in real time, and when a current position of the robotic arm is located on one of the motion nodes, selecting the first focus and zoom parameters corresponding to the one of the motion nodes; when the current position of the robotic arm is located between two adjacent motion nodes, calculating second focus and zoom parameters corresponding to the current position via the interpolation algorithm.

In the dynamic pre-adjustment step, when the robotic arm performs the linear motion between the two adjacent motion nodes, the interpolation algorithm adopts a linear interpolation method to calculate a second focus parameter corresponding to the current position by the formula (1) and a second zoom parameter corresponding to the current position.

The formula (1) is as follows:

$$v = a + \frac{b - a}{t} \times {t}_{current} .$$

In the formula (1), v represents the focus parameter at the current moment. A represents the first focus parameter of the starting motion node A of the two adjacent motion nodes. b represents the first focus parameter of an end motion node B. t represents the total time required for the robotic arm to move from the starting motion node A to the end motion node B. t_{current} represents the time period since the robotic arm started from the starting motion node A, that is, the time difference between the current moment and the starting time.

When the robotic arm performs the non-linear motion between the two adjacent motion nodes, the interpolation algorithm adopts the distance-measurement interpolation method to calculate the second focus and zoom parameters of the current position based on the distance between the current position of the robotic arm and the shooting target, by preset relationship functions f(x) and g(x) of the distance v. Calculation steps comprise steps 1-3.

The step 1 comprises dividing the path between the two adjacent motion nodes into n division points according to a motion trajectory distance of the robotic arm.

The step 2 comprises for each of the division points, calculating the distance x between each of the division points and the shooting target.

The step 3 comprises calculating the second focus and zoom parameter by preset relationship functions v=f(x) and z=g(x).

The second control step comprises generating, by the control module, the shooting device control instructions based on the target focus and zoom parameters obtained in the dynamic pre-adjustment step, and sending the shooting device control instructions to the shooting device.

The image acquisition step comprises dynamically adjusting a focus position and a zoom magnification of a lens, by the shooting device, according to the shooting device control instructions to perform image acquisition. In this way, clear images and smooth transitions are ensured.

Optionally, the robotic arm shooting control system achieves real-time feedback and fine-tuning.

The control module receives distance information fed back by the distance detection device installed on the robotic arm in real time. When a difference is found between real-time distance data and the distance corresponding to the target focus and zoom parameters, the control module fine-tunes the target focus and zoom parameters of the shooting device based on the real-time distance to ensure clear imaging of the shooting target.

During the motion of the robotic arm, the AI distance measurement module periodically acquires the images of the shooting target, and calculates a real-time distance through image preprocessing and feature extraction. The control module fine-tunes the target focus and zoom parameters of the shooting device based on the difference between the real-time distance and the current distance determined by the target focus and zoom parameters.

### Example 1: Linear Motion Scenario

In an advertisement shooting, the robotic arm is required to carry the camera to move along a straight line from a position A (i.e. the motion node A) to a position B (i.e., the motion node B) to shoot a close-up of a product. A user presets a linear motion trajectory of the robotic arm on the host machine, and presets first focus and zoom parameters respectively at the position A and the position B.

The control module adopts the linear interpolation method to calculate the target focus and zoom parameters to be adjusted at the current position according to the formula (1), ensuring smooth transition of the first and second focus and zoom parameters of the shooting device and continuity of images during the motion of the robotic arm.

### Example 2: Non-Linear Motion Scenario

In a film shooting, the robotic arm is required to perform a curved motion around an actor to shoot transitions between medium shots and long shots. Since the motion trajectory of the robotic arm is non-linear, the user presets the first focus and zoom parameters of motion nodes on the host machine.

The control module adopts the distance measurement interpolation method, by the distance detection device or the AI distance measurement module to calculate the distance between the current position of the robotic arm and the actor in real time, and calculates target focus and zoom parameters based on distance functions, ensuring that the actor is always clear in the image and the composition is reasonable.

### Example 3: Real-Time Feedback and Fine-Tuning

In a complex industrial inspection scenario, a position of the shooting target may change slightly.

Therefore, the control module acquires the distance between the shooting device and the shooting target in real time through the distance detection device, and immediately fine-tunes the target focus and zoom parameters after discovering a deviation, ensuring clear images.

The robotic arm shooting control system and method of the present disclosure achieve synchronous control of the robotic arm and the shooting device by presetting the motion trajectory of the robotic arm and the first focus and zoom parameters of the shooting device in the host machine, solving a problem in the prior art that parameters of the shooting device are unable to be adjusted in real time during the motion of the robotic arm.

The robotic arm shooting control system and method of the present disclosure are able to synchronously control the robotic arm and the shooting device, improving shooting quality. Through coordinated control of the robotic arm and the shooting device by the control module, the target focus and zoom parameters of the shooting device are able to be adjusted in real time along with the motion of the robotic arm, ensuring that the shooting target is always in clear focus and appropriate composition, thereby improving image quality.

The robotic arm shooting control system and method of the present disclosure are able to dynamically adjust the target focus and zoom parameters, making captured images smooth and coherent. By adopting the interpolation algorithm, the target focus and zoom parameters of the shooting device are smoothly adjusted during the motion of the robotic arm, avoiding the problem of image incoherence caused by sudden parameter changes and ensuring the continuity and stability of the images.

The robotic arm shooting control system and method of the present disclosure are able to flexibly adapt to various motion modes. The robotic arm shooting control system supports the linear interpolation method and the distance measurement interpolation method, which adapt to linear and non-linear motions of the robotic arm, and is suitable for various shooting scenarios such as advertisements, films, and industrial inspection, enhancing the applicability of the robotic arm shooting control system.

The robotic arm shooting control system is able to feed back the current position of the robotic arm in real time, ensuring imaging quality. Through the position feedback device and the distance detection device, the control module is able to acquire a positional relationship between the robotic arm and the shooting target in real time, and adjust the target focus and zoom parameters of the shooting device in time, avoiding degradation of imaging quality caused by position deviation.

The robotic arm shooting control system is able to improve work efficiency and simplify operations. The motion trajectory and the first focus and zoom parameters of the robotic arm are preset in the presetting stage, which reduces workload of manual adjustment during the shooting process and improves work efficiency. Meanwhile, the user interface is friendly, facilitating parameter setting and adjustment by users.

The robotic arm shooting control system uses AI technology for assistance to achieve accurate focusing. The robotic arm shooting control system introduces the AI distance measurement module, utilizing image processing and deep learning technologies to accurately calculate the distance between the shooting device and the shooting target, assisting in the adjustment of the target focus and zoom parameters, and further improving shooting precision and image quality.

Specifically, when the robotic arm is located between two adjacent motion nodes, the second focus and zoom parameters of the current position are generated through real-time dynamic calculation by the interpolation algorithm. The second focus and zoom parameters of the current position are between the first focus and zoom parameters of the two adjacent motion nodes, rather than directly using the first focus and zoom parameters of the two adjacent motion nodes. In the presetting stage, the robotic arm shooting control system presets the first focus and zoom parameters on each of the motion nodes, that is, the first focus and zoom parameters are statically preset values. When the robotic arm is located between the two adjacent motion nodes, the robotic arm shooting control system is unable to directly apply the first focus and zoom parameters of a certain motion node, but requires transition values. Therefore, the interpolation algorithm dynamically calculates the second focus and zoom parameters of the current position based on the first focus and zoom parameters of the two adjacent motion nodes, allowing the second focus and zoom parameters to transition smoothly between the two adjacent motion nodes. The interpolation algorithm does not reset or acquire new focus and zoom parameters, but generates the second focus and zoom parameters of the current position in real time based on the first focus and zoom parameter of the two adjacent motion modes. Such a calculation is completed in real time during the shooting process to adapt to changes in the current position of the robotic arm, thereby achieving smooth adjustment of images. Therefore, the second focus and zoom parameters of the current position are dynamically calculated and generated through the interpolation algorithm. It is noted that the second focus and zoom parameters are dynamically generated values depending on the first focus and zoom parameters preset for the two adjacent motion nodes rather than re-ranging or re-acquiring new focusing and zooming data.

Specifically, when the robotic arm is located between any two adjacent motion nodes, the second focus and zoom parameters of the current position are generated through real-time dynamic calculation. The process involves calculating between the first focus and zoom parameters of the two adjacent motion nodes according to the interpolation algorithm to obtain appropriate parameters for the current position, thereby ensuring a smooth transition of focus and zoom during the shooting process. Before shooting, in the presetting stage, the robotic arm shooting control system presets the first focus and zoom parameters at various motion nodes through AI distance measurement or other methods. The first focus and zoom parameters are fixed and stored in the robotic arm shooting control system for direct use during shooting. During the shooting process, when the robotic arm is located at one of the motion nodes, the robotic arm shooting control system directly calls the corresponding first focus and zoom parameters of the one of the motion nodes. When the robotic arm is located between any two adjacent motion nodes, the robotic arm shooting control system calculates the second focus and zoom parameters corresponding to the current position in real time through the interpolation algorithm. The second focus and zoom parameters are not preset but are dynamically generated based on the first focus and zoom parameters of the two adjacent motion nodes. In other words, the first focus and zoom parameters and the second focus and zoom parameters jointly form the target focus and zoom parameters.

For example, assuming that the first focus parameter of the motion node A and the first focus parameter of the motion node B are respectively a and b. When the robotic arm moves between the motion modes A and B and the current position is at 50% of a distance from the motion node A to the motion node B, the interpolation algorithm is able to calculate that the second focus parameter of the current position is (a+b)/2. The calculation of the second focus parameter is a real-time interpolation calculation process to ensure that a parameter change from a to b is smooth. In this way, the second focus and zoom parameters are calculated in real time through the interpolation algorithm, which ensures a smooth transition during the shooting process, thereby avoiding the problem of image incoherence caused by sudden parameter changes.

The user is able to establish communication with the robotic arm by scanning the QR code. A specific scheme is that when scanning the QR code, the user initiates a connection request to the server to request connection to the robotic arm, the host machine of the robotic arm is connected to the server via TCP and monitors a scan code request from the user terminal, and after monitoring the scan code request from the user terminal, the host machine sends an instruction to notify the control board that the user requests to operate the robotic arm through the scan code request, thereby establishing a connection between the user terminal and the control module. Then, the user is able to initiate a shooting instruction to the control board to control the robotic arm and the shooting device to perform shooting. The scan code control mode allows an operator to stay away from the robotic arm, ensuring the safety of the operator.

The control module comprises the sound receiving module, allowing the user to control execution through the voice control mode. When the user sends a voice instruction to the voice control module through a microphone or other means, the voice control module receives the voice instruction and performs voice recognition. The voice recognition is to judge the content of the voice instruction, and when the voice instruction is a normal control instruction, the voice instruction is sent to the control module for instruction processing to execute a corresponding action; for example, controlling the robotic arm to shoot through voice.

The control module is electrically connected with or communicated with the robotic arm, and the control module sends the robotic arm control instruction to the robotic arm to control the robotic arm to move along the motion trajectory. The control module is connected to the robotic arm via Ethernet or WIFI, and sends and receives data using TCP/HTTP protocols. The robotic arm control instruction comprises: sending a program name (sent through port 8082); sending program content (sent through the port 8082); starting joint motion, starting arc motion, starting linear motion, starting single-axis jogging; executing joint space planning data when a servo is in place, executing Cartesian space planning data when the servo is in place, starting full circle motion, performing spline curve planning; starting by a spline curve start, ending by the spline curve, starting program execution, stopping program execution, pausing program execution, continuing program execution; control box digital output, analog output, analog input; end-effector digital output, digital input, analog output, analog input, robotic arm mode switching, setting a robotic arm motion speed, setting a robotic arm installation position, setting a collision level, setting a robotic arm positive limit angle, setting a robotic arm negative limit angle, setting tool calibration points, calculating a tool coordinate system, setting tool center point (TCP) coordinates, setting workpiece calibration points, calculating a workpiece coordinate system, setting a workpiece coordinate system; setting a tool list, setting a workpiece list, setting an end-effector load weight; setting end-effector load centroid coordinates, acquiring a current joint configuration of a robot, and robotic arm enabling/disabling; arc starting, arc ending, laser on, laser off; starting tracking and stopping tracking; positioning start, positioning end, swing parameter setting, starting swing, stopping swing, end-effector sensor configuration, end-effector sensor activation, end-effector sensor register writing, force sensor configuration, force sensor activation, and force sensor collision protection, setting a force sensor reference coordinate system, force sensor zeroing, and constant force control, returning a current actual angle of a joint and returning a current actual radian of the joint, returning a current actual speed of the joint, returning a current actual angular speed of the joint; returning a current joint torque, returning a current load weight, returning a current load centroid, returning a current tool target pose, returning a joint soft limit angle, acquiring sensor data in a reference coordinate system, and acquiring raw data in a sensor coordinate system.

The camera control instructions comprise the shooting device control instructions, which are configured to set an automatic focus or a manual focus; and set a zoom magnification (Zoom in or Zoom out). When Zoom in is set, an image is zoomed in, and when Zoom out is set, the image is zoomed out. A specific zoom parameter is able to be set within a range designated according to the camera, such as a zoom parameter range of 0-31. The camera control instruction is configured to set the focus parameter. When a manual focus is set, the camera receives a focus instruction from the host machine to set a designated focus parameter. The camera control instruction further comprises following function settings: metering, ISO, exposure, aperture, shutter, angular velocity, white balance, sharpness, contrast, saturation, brightness, etc. The camera control instruction further comprises acquiring camera information, synchronizing camera time, camera system shutdown or restart, setting a camera working mode, and switching the working mode, such as switching to a video recording mode, a video playback mode, a standby mode, etc. The camera control instruction further comprises changing a stream source, a built-in streaming service, a bit rate, stream segmentation, a stream frame rate, an encoder, a bit width, a recommended stream, streaming transmission, etc. The camera control instruction further comprises memory card management, file management, file download, thumbnails, etc.

According to the motion trajectory and the motion time of the robotic arm, distances between the shooting device and the shooting target at the motion nodes of the robotic arm are acquired, and accurate first focus parameters are preset for the shooting device at the motion nodes of the robotic arm. During a motion shooting driven by the robotic arm, the target focus parameter of the camera is dynamically adjusted according to the first focus parameters to perform image acquisition, thereby avoiding accuracy errors and focus delay problems caused by automatic focusing.

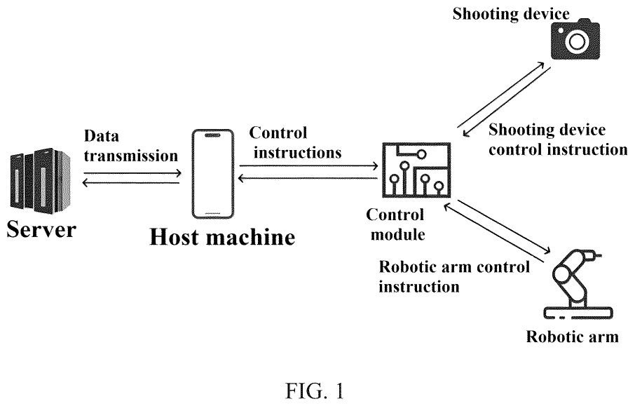

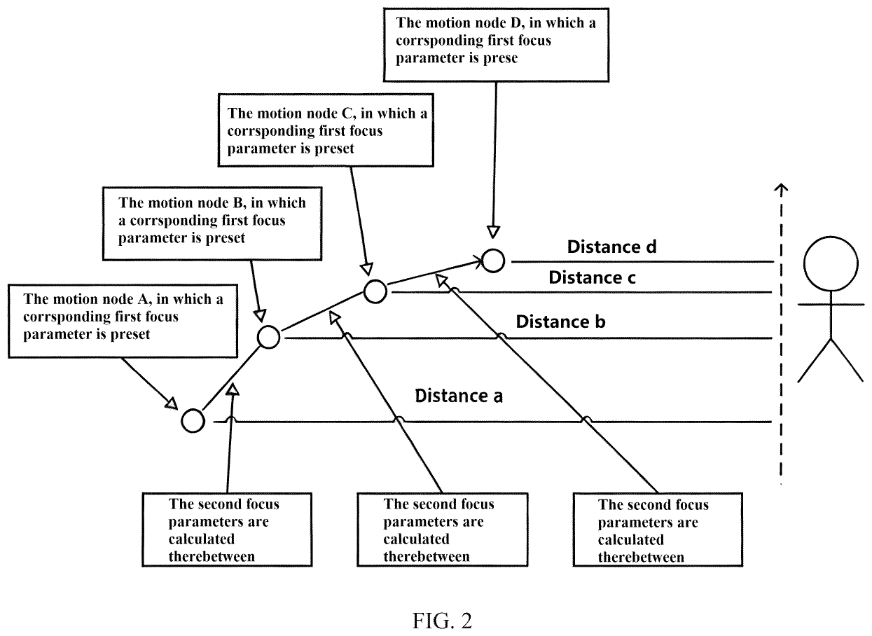

For example, as shown in FIG. 2, the motion trajectory of the robotic arm passes through the motion nodes A, B, C, and D, which are the starting motion node A, intermediate motion nodes B and C, and the end motion node D. At a position of each of the motion nodes, a corresponding first focus parameter is preset according to the distance between the one of the motion nodes and the shooting target, so that the camera is able to capture a clear image at the one of the motion nodes. The focal length value is able to be continuously fine-tuned on the user interface until the clearest image appears. Similarly, different focal length values are respectively set at the motion nodes B, C, and D to maximize image clarity at the motion nodes B, C, and D. The first focus parameters are stored on a readable storage medium.

An accurate first focus parameter is preset at a starting position of the motion of the robotic arm, and an accurate first focus parameter is preset at an end position of the motion of the robotic arm; between the starting position and the end position of the robotic arm, accurate first focus parameters are preset according to a change in the motion trajectory of the robotic arm. The number of preset motion nodes is adjusted according to the change in the motion trajectory of the robotic arm and a change in the distance to the shooting target. The first focus and zoom parameters enable the robotic arm to perform dynamic adjustment according to the first focus and zoom parameters during the motion, so that the captured images always maintain a clear state, and an image blur caused by a change in the distance between the camera and the shooting target is avoided.

When the motion trajectory of the robotic arm and the first focus parameters are stored and determined, and when the user sends the shooting device control instructions and determines the motion trajectory for shooting, the host machine acquires the first focus parameter of each of the motion nodes (such as the motion nodes A, B, C, and D). During mechanical initialization, the first focus parameter of the motion node A is read and sent to the camera for use. When the robotic arm moves from the motion node A to the motion node B, the camera dynamically adjusts the second focus parameters to make the target focus parameters smoothly transition from the first focus parameter of the motion node A to the first focus parameter of the motion node B. Similarly, as the robotic arm moves from the motion node B to the motion node C and then to the end motion node D, the target focus parameters of the camera are dynamically adjusted in sequence according to the first focus parameters of the motion modes B-D, so that the focus of the camera during the entire shooting process is always maintained in the clearest state.

The dynamic focus adjustment refers to dynamically adjusting a focal plane to a designated value during a motion of the camera. For the first focus parameter of any two adjacent motion nodes, smooth focusing setting is achieved by a linear interpolation method or a distance measurement interpolation method.

The linear interpolation method is adopted when the robotic arm moves linearly between two adjacent motion nodes. For example, the robotic arm moves from the motion node A to the motion node B. First, a difference c between the first focus parameter of the motion node A and the first focus parameter of the motion node B is calculated; then, the time t required for the robotic arm to move from the motion node A to the motion node B is calculated; and a time interval y for sending control instructions is calculated by a formula y=t/c. Assuming that the first focus parameter of the motion mode A is a and the first focus parameter of the motion mode B is b, then a sent focus parameter is: v=a+n (where n is a number of times of sending the control instructions after n time intervals). In some embodiments, in a case where the robotic arm performs the linear motion between two adjacent motion nodes, it is more appropriate to use the linear interpolation method for smooth zooming. Specifically, a is the first focus parameter of the starting motion node A, b is the first focus parameter of the end motion node B, and c is a total variation of the focus parameter. c=b−a, which represents a total focus parameter to be adjusted from the motion node A to the motion node B. T is a total time required for the robotic arm to move from the motion node A to the motion node B. y is the time interval for sending focus adjustment instructions, calculated as: y=T/c. n is the number of sent focus adjustment instructions (or the number of elapsed time intervals). v is a second focus parameter at a current moment.

The distance measurement interpolation method is adopted when the motion of the robotic arm between any two adjacent motion nodes is a non-linear motion. For example, when the robotic arm moves from the motion node A to the motion node B, the path thereof is divided into n points based on a distance of the motion trajectory of the robotic arm between the motion node A and the motion node B (n is appropriately set according to the actual motion distance between the two adjacent points). According to the motion trajectory of the robotic arm, the distance between the current point and the shooting target is calculated, and the accurate second focus parameter is determined based on the distance. That is, v=f(x), where x is the distance between one of the motion nodes and the shooting target, and f(x) is a relationship function between distance and focus (which may vary for each camera) that needs to be obtained through experimental methods.

In a case without the AI distance measurement, the shooting target needs to be fixed at a designated position relative to the robotic arm, and the distance between each of the motion nodes of the robotic arm and the shooting target is calculated based on an initial distance. The AI distance measurement module, such as the ranging sensor, is installed at the one end of the robotic arm to detect the distance between the camera and the shooting target. After acquiring the distance between the camera and the shooting target, the target focus parameters are adjusted in real time based on the dynamic distance, so that the captured images always maintain a clear state.

Alternatively, an ultrasonic ranging sensor is installed at the one end of the robotic arm on the same plane as the camera. The ultrasonic ranging sensor measures the distance by emitting ultrasonic waves and receiving reflected waves thereof.

Alternatively, a laser ranging sensor is installed at the one end of the robotic arm to measure the distance by using a transmission time of laser pulses, i.e., measuring a time required for a laser to be emitted, reflected by the shooting target, and returned to a receiver.

Alternatively, an infrared ranging sensor is installed at the one end of the robotic arm to detect the distance of an obstacle (i.e., the shooting target) by using different intensities of infrared signals reflected back when encountering the obstacle.

Alternatively, a millimeter-wave radar ranging sensor is installed at the one end of the robotic arm to measure the distance by using reflections of millimeter waves (electromagnetic waves with a wavelength between centimeters and millimeters).

The installation position of the ranging sensor is on the same plane as the camera to measure the distance between the camera and the shooting target, and a sampling frequency of the ranging sensor is between tens of milliseconds and one hundred milliseconds.

The focus is set based on distance: For the camera, when setting the focus by sending a designated instruction (i.e., assigning a designated value to the focal plane) is supported, the focus is set according to the distance between the camera and the shooting target by following steps 1-3.

The step 1 comprises determining a relationship between the focal length and the focus distance.

First, based on the relationship between the focal length and the focus distance of the camera. The focal length determines a field of view and a depth of field of the lens, while the focus distance refers to a distance from the lens to a clear imaging plane of the shooting target. Lenses with different focal lengths have different ranges and characteristics of focus distances. A relationship function is designed according to the characteristics.

The step 2 comprises measuring distance.

The ranging sensor is provided to dynamically measure the actual distance between the camera and the shooting target. The target focus parameters are calculated according to the relationship function in the step 1, and a required focal length value is calculated by a formula according to the focal length range and depth-of-field characteristics of the camera. Reference to a user manual of the camera is required to obtain specific information.

The step 3 comprises sending focus instructions.

The focus instructions are sent through the control interface of the camera according to the calculated focal length values, so that the captured images maintain a clear state.

Before the robotic arm starts shooting, a frame of image is captured in advance, and the distance between the camera and the shooting target is calculated through computer vision technology and deep learning algorithms. Specific steps comprise steps S1-S4. The step S1 comprises image acquisition: acquiring an image. The step S2 comprises image preprocessing: performing processing such as denoising and enhancement on the image. The step S3 comprises feature extraction: extracting key features such as an edge feature, a shape feature, and a color feature of the shooting target from the image. The step S4 comprises distance calculation: calculating the distance between the shooting target and the camera based on the dimensions of the shooting target and position information in the image, combined with parameters of the camera (focal length, sensor size).

The robotic arm shooting control system comprises a user interface capable of controlling the robotic arm to pause at any time point, configured for allowing the user to preset the first focus parameter of the current time, while enabling preview of clarity of the camera image to ensure accuracy of parameter settings. In the user interface, the user is further able to fine-tune the first focus parameters and manually adjust the first focus and zoom parameters at specific motion nodes until a current captured image is clearly displayed.

According to the motion trajectory and the motion time of the robotic arm, zoom data (first zoom parameters) are preset for the camera at the motion nodes of the robotic arm. When the robotic arm drives the camera to perform motion shooting, the camera adjusts the target zoom parameters according to the zoom data, so that a captured work undergoes zoom-in or zoom-out transformation according to the zoom data preset by the user, thereby enriching shooting content.

During the motion of the robotic arm, the first zoom parameters are preset according to spatial nodes or time nodes. Each of the spatial nodes refers to presetting a first Zoom parameter at a certain position after the robotic arm moves to the position; each of the time nodes refers to setting the first zoom parameter at a certain time point after the robotic arm moves for a designated duration. During motion shooting of the robotic arm, when the robotic arm moves to the designated spatial node or time node, a zoom instruction is sent to perform a zooming action on the camera, so that the captured work is zoomed in or out at the designated position.

The motion trajectory of the robotic arm is known, and thus a time required for the robotic arm to move from the starting point to the end point is also known. For example, when the time required from the starting point to the end point is n seconds, the user is able to set zooming nodes within a time period of 0-n seconds. Zooming is designated by the user; a specific time to start zooming and a specific zoom parameter are preset by the user. The user interface is introduced, which comprises a timeline with a time range from 0-n seconds. The user selects a certain time point a on the timeline and sets an initial zoom parameter za at this time point, and then selects a second time point b and sets a zoom parameter zb at this time point. During a motion of the robotic arm, the Zoom instructions are sent to set the Zoom to the value za when the robotic arm moves to the time point a and to set the Zoom to the value zb when the robotic arm moves to the time point b. Thus, during a video generation process, it is seen that the video achieves a zooming change from the time point a to the time point b.

During the motion of the robotic arm, between the first zoom parameters of two adjacent time points (for example, two adjacent motion nodes from the time point A to the time point B), the host machine dynamically sends zoom instructions based on a difference between the first zoom parameters of the time point A and the time point B, so that the target zoom parameters of the camera continuously increase/decrease from the first zoom parameter of the time point A and transition smoothly to the first zoom parameter of the time point B, thereby enabling smooth changes of the target zoom parameters during the entire shooting process and achieving smooth scaling display of the captured images.

The robotic arm shooting system further comprises storage medium. The storage medium is a computer-readable storage medium for storing a computer program. When the computer program is executed, the robotic arm shooting control method is executed. The computer program is stored in the host machine and the control module. The host machine is connected to the control module and the camera, and sends control instructions via BLUETOOTH or WIFI to achieve corresponding functions.

After data is acquired by the camera, the user is able to perform video processing according to video processing methods provided by the robotic arm shooting control system. The processing methods comprise: video slow motion, video fast/slow variable speed, video forward or reverse playback, generating video according to a designated variable speed mode, etc. The robotic arm and control instructions thereof are described as follows.

The robotic arm comprises a control box, and the control box comprises a control input/output (I/O) for controlling various devices, such as a pneumatic relay, a Programmable Logic Controller (PLC), and an emergency stop button. A network interface group in the control box comprises a user network port configured to communicate with an external device. I/O and a 485 communication interface of an end-effector plate are configured to control various devices, such as the pneumatic relay, the PLC, and the emergency stop button. An I/O connector model is an M12 connector 8-pin female head. The robotic arm is connected through a network, and a robotic arm control terminal interface is displayed on a personal computer (PC). The control interface comprises a three-dimensional model of the robotic arm. An I/O setting interface is entered through the control interface. The I/O setting interface achieves digital outputs, analog outputs (0-10v), and digital outputs of an end-effector tool, as well as manual control of the analog outputs (0-10v) of the control box of the robotic arm. For a DO operation, a port number is selected; when the DO is at a low level, an operation button on the right side displays “ON”, and the DO is set to a high level by clicking the button. For an AO operation, a port number is selected, and a value (0-100) is input in an input box on the right side; the value is a percentage, and setting 100 means setting the AO port to 10v. A state display area on the right side of the three-dimensional model displays a current state of the I/O; in digital inputs and digital outputs, if the port is high level, the point is displayed in green, and if it is low level, the point is displayed in white. Displayed values of analog inputs and analog outputs are 0-100, where 100 represents 10v.

On the control interface, click the “I/O filtering” sub-menu to enter an I/O filtering time setting interface. The I/O filtering time setting interface comprises: a control box digital input (DI) filtering time, an end-effector plate DI filtering time, a control box AIO filtering time, a control box AIl filtering time, and an end-effector plate AIO filtering time. The user is able to set corresponding parameters according to requirements and click a corresponding setting button.

An IP address of a robotic arm controller is 192.168.57.2. A button box interface defaults to a teach pendant control port with an IP address of 192.168.58.2. A network cable is configured to connect the button box interface and a computer, and an IP address of the computer is set to 192.168.58.10 or the same network segment. A teach pendant page is accessed by opening a browser and inputting 192.168.58.2. The control box accesses the teach pendant page by connecting to the network port of the button box. Click a “teach simulation” button on the teach pendant and click its sub-menu “program teaching” to enter a program teaching interface, which mainly implements writing and modification of a robotic arm teaching program. After clicking a “New” icon button, the user names the file, selects a template as content of the new file, and clicks “New” to successfully create and open the program file.

Robotic arm user accounts are mainly divided into three levels: the operator is able to use a small portion of functions, a programmer has some functional restrictions, and an administrator has no functional restrictions. Specifically, a manual high-speed function serves as a relatively important safety protection function and is only allowed to be used by the programmer and the administrator. The operator is not allowed to use the manual high-speed function; that is, when the operator controls the robotic arm to move in a manual mode, the maximum speed the robotic arm is 250 mm/s to provide protection.

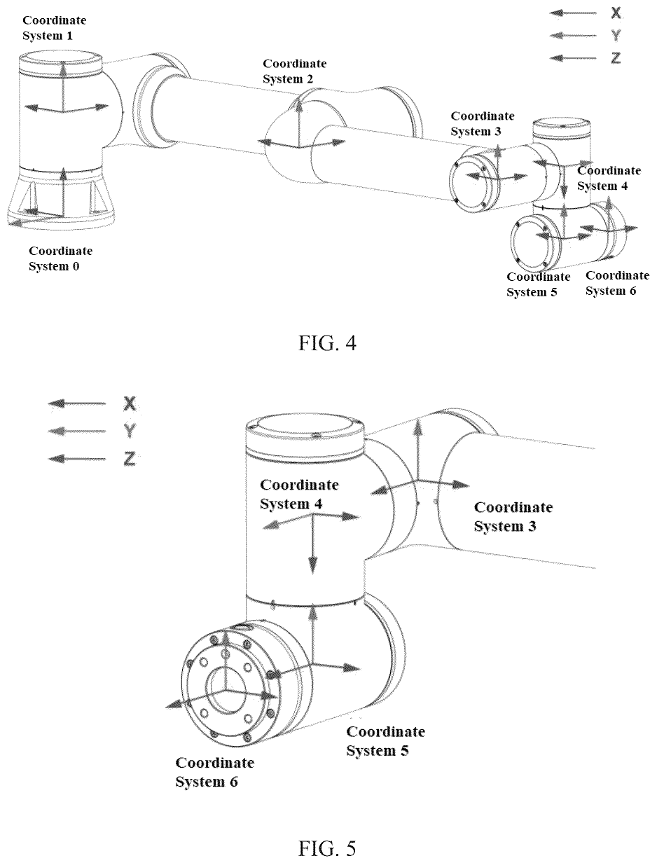

On the control interface of the host machine, various types of three-dimensional virtual coordinate systems may be created. Taking a base coordinate system as an example for display, as shown in FIGS. 4 and 5, an X-axis is red, a Y-axis is green, and a Z-axis is blue. The base coordinate system is displayed by default in a three-dimensional virtual area of the robotic arm in the controller interface, and is fixedly marked at a center of a bottom of a base of the robotic arm. The display of the base coordinate system is able to be manually turned off.

A tool coordinate system of the robotic arm is displayed by default. After the control interface is started and the user logs in successfully, a name and corresponding parameter data of a currently applied tool coordinate system are acquired to initialize a current tool coordinate system. When another tool coordinate system is applied during use, after a tool coordinate system application instruction is successfully executed, an existing tool coordinate system in the three-dimensional virtual area of the robotic arm is first cleared, and then parameter data of a newly applied tool coordinate system is input into a three-dimensional coordinate system for generating an application programming interface (API) for generating the newly applied tool coordinate system. After generation, the newly applied tool coordinate system is displayed in the three-dimensional virtual area. The display of the three-dimensional virtual tool coordinate system may be manually turned off. The workpiece coordinate systems are closed by default and may be manually turned on for display. Display process thereof is consistent with that of the tool coordinate system. An external axis coordinate system is closed by default and may be manually turned on for display. Display process thereof is consistent with that of the tool coordinate system.

Click “soft limit” on the control interface to enter a soft limit interface. Other devices may exist within a stroke of the robotic arm, and it is necessary to perform a soft limit on the robotic arm to prevent the robotic arm from moving beyond a certain coordinate value, thereby preventing a collision of the robotic arm with other devices. Stopping the robotic arm by triggering the soft limit is automatically triggered by the robotic arm without a stopping distance. The administrator is able to use default values or input angle values. By inputting angle values, positive and negative angles of joints of the robotic arm are respectively limited. When an input value exceeds a designated soft limit angle value of the joints of the robotic arm, the limit angle is adjusted to a maximum preset value. When the robotic arm reports an instruction limit-over error, the robotic arm enters a drag mode, and the joints of the robotic arm need to be dragged within the limit angles.

Under joint operation, six slider bars in the middle represent angles of corresponding axes, respectively. A joint motion is divided into single-axis jogging and multi-axis linkage. The user is able to control the motion of the robotic arm by operating circular buttons on the left and right sides. In a manual mode and the joint coordinate systems, a rotation operation is performed on a certain joint of the joints of the robotic arm. When the robotic arm stops due to exceeding a motion range (soft limit), the single-axis jogging is utilized for manually moving the robotic arm out of a limit-over position. The single-axis jogging is faster and more convenient than other operation modes when performing rough positioning and large-scale movement. A “long-press motion threshold” parameter (a maximum distance the robotic arm runs when a button is long-pressed, with an input value range of 0-300) is set; the circular button is long-pressed to control the robotic arm to run. When the circular button is released during the running of the robotic arm, the robotic arm stops moving immediately. When the circular button is held down without being released, the robotic arm stops moving after running for the value set by the long-press motion threshold.

The multi-axis linkage is described as follows. The user is able to operate the six slider bars in the middle of the control interface to adjust a corresponding target position of the robotic arm, and the target position is determined by observing the three-dimensional virtual robotic arm. When an adjusted position does not meet expectations, a “Restore” button is clicked to make the three-dimensional virtual robotic arm return to an initial position. When the user determines the target position, an “Apply” button is clicked, and the physical robotic arm performs a corresponding motion.

Base jogging is described as follows. In the base coordinate system, the circular buttons on the left and right sides are operated to control the robotic arm to move linearly along X, Y, and Z axes or rotate around RX, RY, and RZ. The six slider bars in the middle of the control interface represent positions and motion ranges on corresponding coordinate axes, respectively. A function of the base jogging is similar to that of the single-axis jogging in the joint motion.

Tool jogging is described as follows. By selecting the tool coordinate system, the circular buttons on the left and right sides of the control interface are operated to control the robotic arm to move linearly along X, Y, and Z axes or rotate around RX, RY, and RZ; the six slider bars in the middle of the control interface represent positions and motion ranges on corresponding coordinate axes, respectively. A function of the Tool jogging is similar to that of the single-axis jogging in the joint motion.

Wobj jogging is described as follows. By selecting workpiece jogging, the circular buttons on the left and right sides of the control interface are operated to control the robotic arm to move linearly along X, Y, and Z axes or rotate around RX, RY, and RZ in the workpiece coordinate system; the six slider bars in the middle of the control interface represent positions and motion ranges on corresponding coordinate axes, respectively. A function of the Wobj jogging is similar to that of the single-axis jogging in the joint motion.

By selecting “Move”, Cartesian coordinate values are directly input; by clicking “Calculate joint position”, and a joint position is displayed as a calculated result. After confirming there is no danger, “Move to this point” can be clicked to control the robotic arm to move to the input Cartesian pose.

Teach pendant programming of the robotic arm is described as follows. Operational steps of a teach pendant programming (TPP) function are as follows.
(1) An initial position is recorded by entering an operation area on the left side of a three-dimensional model to record a current position of the robotic arm; setting a name of a point in an editing box and saving it.
(2) trajectory recording parameters are configured by entering a “TPP” function item to configure trajectory recording parameters, setting a name of a trajectory file, a pose type, and a sampling period, and configuring DIs and DOs. During the process of recording a TPP trajectory, a corresponding digital output (DO) to be output is recorded by triggering a DI.
(3) click a robotic arm mode, which comprises checking whether the robotic arm is in the manual mode; if not, switching to the manual mode. In the manual mode, switching the robotic arm to a drag teaching mode is achieved through two ways: a first one is long-pressing an end-effector button, and the other one is to trigger a drag mode switching button on the control interface. During TPP recording, it is recommended to switch the robotic arm into the drag teaching mode from the control interface.
(4) Start recording, which comprises clicking a “Start Recording” button to start trajectory recording, and dragging the robotic arm to perform action teaching. In addition, there is a “TPP recording start/stop” function configuration item in end-effector DI configurations; by configuring the function, the user is able to trigger a “Start Recording” trajectory function through an external signal. It should be noted that to start recording a trajectory through an external signal, information configuration of the TPP trajectory must first be performed on the page.
(5) stopping recording, which comprises after the action teaching is completed, clicking a “Stop Recording” button to stop the trajectory recording, and then making the robotic arm exit the drag teaching mode through the drag teaching switching button. When the teach pendant receives “Stop trajectory recording successful”, it indicates that the trajectory recording is successful. Similar to the step (4), after configuring the “TPP recording start/stop” function, stopping recording is triggered through an external signal.
(6) Teach programming, which comprises clicking “New”, selecting a blank template, clicking to enter a PTP function programming item, selecting the just-saved initial position point, and clicking an “Add” button; after application, a PTP instruction is displayed in the program file. Then, clicking to enter a TPP function programming item, selecting the just-recorded trajectory, setting whether it is smoothly transitioned and setting a speed scaling ratio, and clicking the “Add” button; after application, a MoveTPP instruction is displayed in the program file. To start recording the trajectory by using the external signal, the TPP trajectory information is first configured on the page.
(7) Trajectory reproduction, which comprises after editing of a teaching program is completed, switching to an automatic running mode and clicking a “Start Running” icon at a top of the control interface to start running the program, and the robotic arm starts to reproduce taught actions.
(8) Trajectory editing, which comprises a TPP trajectory editing area allows for visual display, editing, and cropping of the trajectory to achieve pre-analysis and streamlining of the TPP trajectory. By selecting corresponding trajectory acquisition points, trajectory points recorded by the user are displayed in a three-dimensional space of the robotic arm. Furthermore, the “Start” and “End” scroll bars are dragged to perform simulated reproduction and clipping of a starting point and an end point of the trajectory.

There are mainly two types of operations for adding a program instruction to a file: a first one is to open a relevant instruction and click an application button to add the instruction to a program, and a second one is to click an “Add” button first, at which time the instruction is not saved to the program file, and then click “Apply” to save the instruction to the file. The second type occurs mostly when multiple instructions of the same type are issued. For this type of instruction, the “Add” button and a function for displaying added instruction content are added. A single instruction may be added by clicking the “Add” button, the added instructions display all added instructions, and the added instructions are saved to an opened file on the right side by clicking “Apply”.

The program instruction comprises a PTP instruction. Specifically, selecting a spatial position point to be reached, and a smooth transition time setting achieves that a motion from the spatial position point to a next spatial position point is continuous. Whether to set an offset is selected from an offset based on the base coordinate system and an offset based on the tool coordinate system, and offset settings for x, y, z, rx, ry, rz are popped up. A specific PTP path is an optimal path automatically planned by a motion controller.

The program instruction comprises a Lin instruction. A function of the Lin instruction is similar to that of the PTP instruction, but a path of the Lin instruction to an end point is a straight line.

The program instruction comprises an Arc instruction: The Arc instruction represents an arc motion, which comprises two points. A first point is an arc intermediate transition point, and a second point is an end point. Whether to set an offset is configured for both the transition point and the end point, selecting from an offset based on the base coordinate system and an offset based on the tool coordinate system, and offset settings for x, y, z, rx, ry, rz are popped up, and a smooth transition radius is set for the end point to achieve a continuous motion effect.

The program instruction comprises a Circle instruction. The Circle instruction represents a full circle motion, which comprises two points. A first point is a full circle intermediate transition point 1, and a second point is a full circle intermediate transition point 2. Whether to set an offset is configured for the transition point 2, and the offset takes effect for both the transition point 1 and the transition point 2 simultaneously.

The program instruction comprises a Spiral instruction: The Spiral instruction represents a spiral motion, which comprises three points that form a circle. On a setting page for a third point, parameter settings including a number of spiral turns, a posture correction angle, a radius increment, and an axis direction increment are included. The number of spiral turns is a number of motion turns of the spiral; the posture correction angle corrects a posture at an end of the spiral and a posture at a first point of the spiral. The radius increment is an increment of a radius per turn, and the axis direction increment is an increment in a direction of a spiral axis. Whether to set an offset is configured, and the offset takes effect for the trajectory of the entire spiral.

The program instruction comprises an N-Spiral instruction. The N-Spiral instruction is an optimized version of the spiral motion, which achieves the spiral motion with only one point plus configuration of various parameters. With a current position of the robotic arm as a starting point, the user sets parameters including a debugging speed, whether to set an offset, a number of spiral turns, a spiral inclination angle, an initial radius, a radius increment, an axis direction increment, and a rotation direction. The number of spiral turns is a number of motion turns of the spiral. The spiral inclination angle is an angle between a tool Z-axis and a horizontal direction. A posture correction angle corrects a posture at an end of the spiral and a posture at a first point of the spiral. The initial radius is a radius size of a first turn. The radius increment is an increment of a radius per turn. The axis direction increment is an increment in a direction of a spiral axis. The rotation direction comprises clockwise and counterclockwise.

The program instruction comprises a Spline instruction. The Spline instruction is divided into three parts, which are respectively a spline group start, a spline segment, and a spline group end. The spline group start is a starting sign of a spline motion, and the spline segment comprises SPL, SLIN, and SCIRC segments.

The program instruction comprises an N-Spline instruction. The N-Spline instruction is an algorithm optimization instruction for the Spline instruction, which replaces the Spline instruction. The N-Spline instruction is divided into three parts, which are respectively a multi-point trajectory start, a multi-point trajectory segment, and a multi-point trajectory end. The multi-point trajectory start is a starting sign of a multi-point trajectory motion; the multi-point trajectory segment is for setting various trajectory points, and a point addition interface is entered by clicking an icon. The multi-point trajectory end is an end sign of the multi-point trajectory motion, where a control mode and a debugging speed are set. The control mode is divided into a given control point and a given path point.

The program instruction comprises an IO instruction. An IO instruction editing interface is entered by clicking an “IO” icon. The IO instruction is divided into two parts, which are respectively setting an IO (SetDO/SPLCSetDO) and acquiring an IO (GetDI/SPLCGetDI). The “SetDO/SPLCSetDo” instruction is configured to set a designated output DO state, including 16-channel control box digital outputs and 2-channel tool digital outputs. A state option “False” is closed and “True” is open. In a whether to set a blocking option, a “Blocking” option indicates that the DO state is set after a motion stops, and a “Non-blocking” option indicates that the DO state is set during a previous motion process. A smooth trajectory option “Break” indicates that the DO state is set after a smooth transition radius ends, and “Serious” indicates that the DO state is set during a smooth transition radius motion. When the SETDO/SPLCSetDO instruction is added in an auxiliary thread, “Yes” should be selected for whether to apply the thread, and “No” should be selected when the instruction is used in other places. Then, “Add” and “Apply” buttons are clicked after the options are made.

In the “GetDI/SPLCGetDI” instruction, a value of a port number to be acquired is selected, for a blocking option, “Blocking” indicates that a DI state is acquired after a motion stops, and a “Non-blocking” option indicates that the DI state is acquired during a previous motion process. When the instruction is added in an auxiliary thread, “Yes” should be selected for whether to apply the thread, and “No” should be selected when the instruction is used in other places. After selection, click the “Add” and “Apply” buttons.

The program instruction comprises an AI instruction. The AI instruction is divided into two functions, which are respectively setting an analog output (SetAO/SPLCSetAO) and acquiring an analog input (GetAI/SPLCGetAI).

In the “SetAO/SPLCSetAO” instruction, an analog output to be set is selected, and a value to be set is input with a range of 0-10. For a blocking option, a “Blocking” option indicates that an AO state is set after a motion stops, and a “Non-blocking” option indicates that the AO state is set during a previous motion process.

In the “GetAI/SPLCGetAI” instruction, an analog input to be acquired is selected; for the blocking option, a “Blocking” option indicates that an AI state is acquired after a motion stops, and a “Non-blocking” option indicates that the AI state is acquired during a previous motion process. When the “GetAI/SPLCGetAI” instruction is added in an auxiliary thread, “Yes” should be selected for whether to apply the thread, and “No” should be selected when the instruction is used in other places. Then, “Add” and “Apply” buttons are clicked.

The program instruction comprises a TPP instruction. In the TPP instruction, the user first needs to have a recorded trajectory. Regarding trajectory recording, before preparing to record a trajectory, a starting point of the trajectory is saved first. While the robotic arm is in a drag mode, a file name is input, and a period is selected (assuming a value is x, i.e., one point is recorded every x milliseconds, and one point every 4 milliseconds is recommended). Then, click “Start Recording”, and the user is able to drag the robotic arm to perform a designated motion according to requirements; after the recording is completed, click “Stop Recording” to save the previous motion trajectory of the robotic arm. When the motion cannot be fully recorded, a prompt indicating that the number of recorded points exceeds a limit is given, and the user needs to record the motion in several segments. During program programming, a PTP instruction is first configured to reach a corresponding starting point of the motion trajectory, and then a trajectory is selected in a TPP trajectory reproduction instruction, whether it is smooth is selected, a debugging speed is set, and “Add” and “Apply” buttons are clicked in sequence to insert the program. A trajectory loading instruction is mainly configured to pre-read a trajectory file and extract it into trajectory instructions, which is better applied to conveyor belt tracking scenarios.

The program instruction comprises a Mode instruction. The mode instruction is able to switch the robotic arm to the manual mode, and is commonly added at an end of a program so that the robotic arm automatically switches to the manual mode for dragging after the program finishes running.

The program instruction comprises a Pause instruction. The Pause instruction is a pause instruction. When the Pause instruction is inserted into a program and the program is executed, the robotic arm is in a paused state. When it is desired to continue running, the “Pause/Resume” button in a control area is clicked.

The program instruction comprises a Gripper instruction. The Gripper instruction is divided into a gripper motion control instruction and a gripper activation/reset instruction. In the gripper control instruction, a gripper number that has completed configuration and has been activated is displayed; the user is able to set opening/closing, an opening/closing speed, and an opening/closing torque of a gripper through an editing box or by sliding a slider bar to a required value. The value is a percentage. Regarding a blocking function option, a “Blocking” option indicates that a gripper motion needs to wait for a previous motion instruction to finish execution before executing, and a “Non-blocking” option indicates that the gripper motion is parallel to the previous motion instruction.

The program instruction comprises an F/T instruction. The F/T instruction comprises seven instructions, which are respectively an FT_Guard (collision detection), an FT_Control (constant force control), an FT_Spiral (spiral insertion), an FT_Rot (rotational insertion), an FT_Lin (linear insertion), an FT_FindSurface (surface positioning), and an FT_CalCenter (center positioning).

The program instruction comprises a 3D instruction. The 3D instruction is a 3D vision program instance generation instruction. The user is able to refer to a generated program to perform communication work with other vision devices. The 3D instruction comprises two programs, which are respectively a camera calibration program and a camera picking program.

The program instruction comprises a Thread instruction. The Thread instruction is an auxiliary thread function. The user is able to define an auxiliary thread to run simultaneously with a main thread. The auxiliary thread mainly performs data interaction with an external device, supporting socket communication, robotic arm DI state acquisition, robotic arm DO state setting, robotic arm state information acquisition, and data interaction with the main thread; data acquired by the main thread through the auxiliary thread is used for judging motion logic of the robotic arm.

The program instruction comprises a ServoCart instruction, which is a ServoCart servo control (Cartesian space motion) instruction. The ServoCart instruction is able to control the motion of the robotic arm through absolute pose control or an offset based on a current pose. x, y, z, rx, ry, rz (Cartesian positions) are an acquired current position of the robotic arm. In addition, the user is able to control the motion of the robotic arm by reading a trajectory data file, sending trajectory data via socket communication, etc.

The program instruction comprises a Function instruction. The Function instruction is a function for calling a function interface, providing robotic arm interface functions for a customer to select and prompting the customer with parameters required for the function, which facilitates the customer in writing script instructions. More functions are being added.

The program instruction comprises an Xmlrpc instruction. XML-RPC is a remote procedure call method that uses XML over sockets to transfer data between programs. Through XML-RPC is a remote procedure call method, a robotic arm controller is able to call functional functions (which may carry parameters) in a remote program/service and acquire returned structured data. The robotic arm controller is responsible for handling all details of writing XML-RPC client messages and handling conversion between data types and XML.

The program instruction comprises an Acc instruction. The Acc instruction is for implementing a function where acceleration of the robotic arm can be set independently. By adjusting an acceleration scaling factor of a motion instruction, acceleration/deceleration time can be increased or decreased to achieve an adjustable motion cycle time of the robotic arm.

The program instruction comprises a Torque instruction: The Torque instruction is a force compliance control instruction. Through the Torque instruction, during a force control training process, when a force is greater than a certain value, the robotic arm is able to adjust the motion trajectory to reduce the force, and when the force is less than the certain value, the robotic arm returns to an original trajectory and continues to move along the original trajectory.

The program instruction comprises an Aux-IO instruction. The Aux-IO instruction is an instruction function for communication between the robotic arm and a PLC to control external expansion I/Os. It requires establishing UDP communication between the robotic arm and the PLC. Based on original 16-channel inputs and outputs, 128-channel inputs and outputs are expanded. The usage of the Aux-IO instruction is similar to the general IO usage mentioned above.

The robotic arm shooting control system further comprises a robotic arm calibration function.

Under the menu bar of “Robotic arm body” in “Auxiliary application”, “Robotic arm calibration” button is clicked to enter a robotic arm calibration interface. The robotic arm calibration function is mainly configured to perform zero-point position calibration on the robotic arm. Click a “Disable” button, drag each shaft of the robotic arm to move the robotic arm to a zero-point position on the mechanical system, and click a “Zero-point setting” button to set a zero point of the robotic arm.

Zero-point setting is described as follows. An initial pose is preset when the robotic arm leaves a factory, and an angle of each of the joints is 0 in this pose. The zero-point setting refers to a pose of the robotic arm corresponding to each joint moving to a specific position. The zero point is a benchmark of the robotic arm coordinate system, and without the zero point, the robotic arm cannot judge its own position. Therefore, in order to obtain the highest possible absolute positioning accuracy, zero-point calibration must be performed on the robotic arm. Generally, the zero-point calibration is required in following cases: (1) after replacing mechanical system components of the robotic arm; (2) after a violent collision with a workpiece or an environment; (3) when a deviation between an operation such as establishing a coordinate system and an actual position is large; (4) after a whole system is reinstalled; (5) after an encoder battery is replaced; and (6) after moving and transporting the robotic arm over a long distance.

The robotic arm shooting control system has a matrix movement function. Under the menu bar of “Robotic arm body” in “Auxiliary application”, “Matrix movement” button is clicked to enter a matrix movement configuration function interface. The matrix movement function controls regular movement of the robotic arm by setting three-point coordinates and values such as rows, columns, layers, and layer heights, and is suitable for common palletizing applications. A first step is to select a motion mode of the robotic arm, such as “PTP” or “Line”. A second step is to set a motion path of the robotic arm, such as a “Head-to-tail path” or an “S-shaped path”. A third step is to set a stacking mode, such as a “Palletizing” mode or a “Depalletizing” mode. A fourth step is to teach three points according to the motion path, where a first point is a starting point of a first row, and a pose of the robotic arm during the entire motion process is determined by the first point, a second point is an end point of the first row, and a third point is an end point of a last row. A fifth step is to set the number of rows and columns of the points. A sixth step is to set the number of layers and a height of each layer. A last step is to name the matrix movement program file, and then a matrix movement program is successfully generated.

The robotic arm shooting control system has a laser sensor tracking function. Specifically, a “; Laser” instruction is selected on a program teaching instruction interface. Laser-related instructions are integrated therein, and program teaching instructions are added at corresponding positions according to specific program teaching requirements.

The robotic arm shooting control system has a laser sensor trajectory reproduction function. Specifically, a “T-Rec” instruction is selected on the program teaching instruction interface. The “T-Rec” instruction is mainly configured for laser recognition of trajectory starting and end points, and trajectory reproduction, and instructions are added at corresponding positions according to specific program teaching requirements.

Posture adaptive configuration steps of the present disclosure comprise steps 1 and 2.

The step 1 comprises selecting a “Tracking posture configuration” button in a user peripheral configuration interface to enter a posture adjustment configuration interface, selecting a plate type and an actual working motion direction of the robotic arm, adjusting a posture of the robotic arm, and respectively setting a posture point A, a posture point B, and a posture point C. The posture point A is commonly a plane posture point. The posture point B is a rising edge posture point. The posture point C is a falling edge posture point.

The step 2 comprises selecting an “Adjust” instruction on the program teaching instruction interface. Instructions are added at corresponding positions according to specific program teaching requirements.

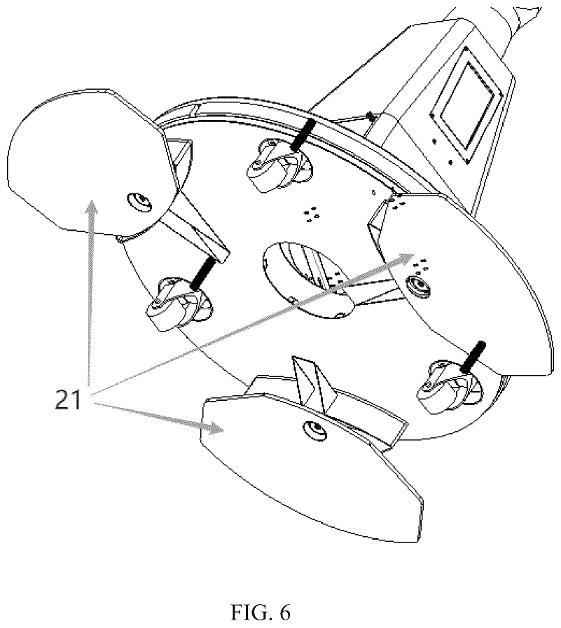

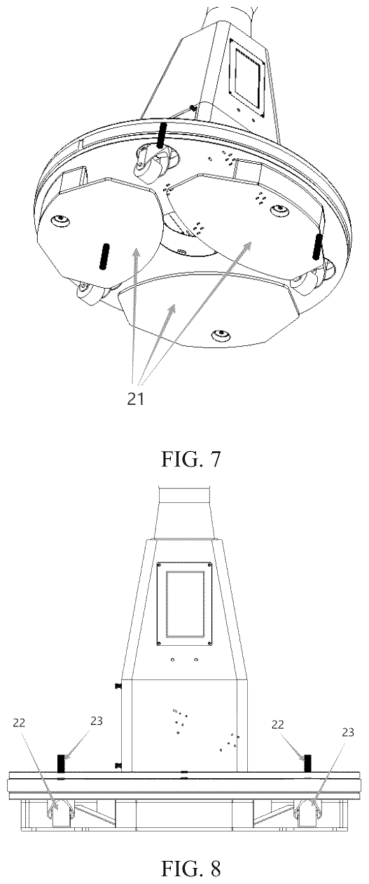

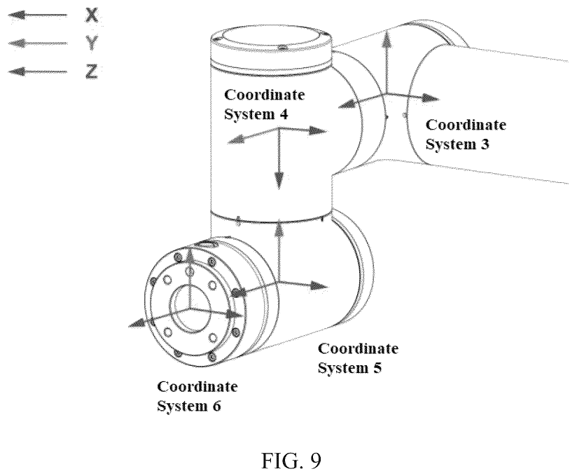

The base of the robotic arm adopts a retractable design. When the robotic arm is working, multi-axis swinging is required, which may cause the base to shake and be unstable. Therefore, the bottom support plates 21 (as shown in FIG. 6) are unfolded to prevent the base from shaking during the work of the robotic arm. However, when the robotic arm does not need to be used, the bottom support plates 21 are retracted (as shown in FIG. 7) to save placement space and facilitate storage. A height of the rollers on the base of the robotic arm is adjustable. The rollers of the robotic arm are adjusted up and down through lead screws. As shown in FIG. 8 and FIG. 9, when the robotic arm needs to be moved, the rollers 22 are adjusted downward so that the rollers 22 contact the ground, and the bottom support plates 21 do not contact the ground. Thus, the robotic arm is able to be moved by pushing the rollers 22, facilitating moving the robotic arm to another place. After the robotic arm is moved to a designated position, the rollers 22 are adjusted upward through the lead screws 23 so that the rollers 22 do not contact the ground and the bottom support plates 21 contact the ground, allowing the robotic arm to work safely.

What is claimed is:

1. A robotic arm shooting control system, comprising:
a host machine;
a shooting device;
a control module; and
a robotic arm;
wherein the control module is configured to communicate with the host machine, control an operation of the robotic arm according to a robotic arm control instruction, and control an operation of the shooting device according to shooting device control instructions;
wherein the robotic arm is communicated with the control module, and the robotic arm is configured to mount the shooting device and drive the shooting device to move along a motion trajectory of the robotic arm according to the robotic arm control instruction;
wherein the motion trajectory of the robotic arm is preset.

2. The robotic arm shooting control system according to claim 1, wherein the host machine is configured to generate the robotic arm control instruction based on the motion trajectory of the robotic arm, to preset first focus and zoom parameters of the shooting device at motion nodes of the robotic arm, and to generate the shooting device control instructions based on the first focus and zoom parameters at the motion nodes;
wherein the shooting device is installed on the robotic arm and is communicated with the control module, the shooting device is configured to dynamically adjust a focus and a zoom thereof during a motion of the robotic arm to capture images;
wherein the control module is further configured to acquire motion trajectory information and a motion time of the robotic arm and perform following operations based on the motion trajectory information and the motion time of the robotic arm:
when a current position of the robotic arm is located at a designated motion node or a designated time node, selecting the first focus and zoom parameters corresponding to the designated motion node; and
when the current position of the robotic arm is located between two adjacent motion nodes, calculating second focus and zoom parameters corresponding to the current position between the two adjacent motion nodes; wherein the second focus and zoom parameters are between the first focus and zoom parameters corresponding to the two adjacent motion nodes

3. The robotic arm shooting control system according to claim 1, wherein the robotic arm shooting control system further comprises a server communicated with the host machine, and the server is configured to store the motion trajectory and first focus and zoom parameters preset by the host machine;
wherein the host machine comprises a user interface, and a user is able to preset the motion trajectory of the robotic arm and first focus and zoom parameters of the shooting device at motion nodes of the robotic arm.

4. The robotic arm shooting control system according to claim 2, wherein the robotic arm control instruction is configured to control at least one of a start, a stop, a trajectory planning, and a speed adjustment of the robotic arm;
wherein the shooting device control instructions are configured to dynamically adjust the focus and the zoom of the shooting device during the motion of the robotic arm according to the first focus and zoom parameters and the second focus and zoom parameters;
wherein when the robotic arm moves linearly between the two adjacent motion nodes, second focus and zoom parameters of the shooting device are adjusted step by step at time intervals by calculating a difference between the first focus and zoom parameters of the two adjacent motion nodes;
wherein when the robotic arm moves non-linearly between the two adjacent motion nodes, a distance measurement interpolation method is adopted to dynamically adjust the target focus and zoom parameters of the shooting device by calculating a distance between the current position of the robotic arm and a shooting target and performing interpolation based on a distance difference.

5. The robotic arm shooting control system according to claim 1, wherein the robotic arm shooting control system further comprises an artificial intelligence (AI) automatic focusing and zooming module based on an AI distance measurement module,
wherein the AI automatic focusing and zooming module is configured to calculate a distance to a shooting target based on an image captured by the shooting device to assist in adjusting target focus and zoom parameters of the shooting device before the robotic arm starts shooting;
wherein the AI automatic focusing and zooming module comprises an image acquisition unit, an image preprocessing unit, a feature extraction unit, a distance calculation unit, a parameter adjustment unit,
wherein the image acquisition unit is configured to acquire the image of the shooting target before the robotic arm starts shooting, the image preprocessing unit is configured to perform denoising and enhancement processing on the image of the shooting target, and the feature extraction unit is configured to extract at least one of an edge feature, a shape feature, and a color feature of the shooting target from a preprocessed image;
wherein the distance calculation unit is configured to calculate a distance between the shooting target and a camera of the shooting device based on a size of the shooting target, position information in the preprocessed image, a focal length and a sensor size of the camera; and at least one of the edge feature, the shape feature, and the color feature of the shooting target;
wherein the parameter adjustment unit is configured to preset the first focus and zoom parameters for the shooting device at each of the motion nodes of the robotic arm according to the distance calculated by the distance calculation unit during a presetting stage.

6. The robotic arm shooting control system according to claim 1, wherein the robotic arm shooting control system further comprises a quick-response (QR) code, the QR code contains a remote control server address of the robotic arm, when a user scans the QR code by a smart terminal device, the smart terminal device automatically jumps to a remote control user interface, the motion trajectory of the robotic arm and/or a shooting mode of the shooting device are selectable via the remote control user interface, when the smart terminal device sends control instructions to the robotic arm and the shooting device, the robotic arm moves according to the motion trajectory, and the shooting device captures the images according to a designated motion trajectory, so that the smart terminal device has a capability of remote control of the robotic arm shooting;
wherein the QR code is further configured as a sharing QR code; the user enters an email address or a mobile phone number in the remote control user interface, and once the robotic arm finishes shooting, shooting works are automatically sent to the email address or a mobile phone with the mobile phone number designated by the user, so that the robotic arm shooting control system has a capability of automatic sharing.

7. The robotic arm shooting control system according to claim 1, wherein different video processing modes and video playback speeds are preset at different motion nodes or time nodes according to the preset motion trajectory of the robotic arm.

8. A robotic arm shooting control method, comprising following steps:
a presetting step: presetting a motion trajectory of a robotic arm and first focus and zoom parameters of motion nodes of the robotic arm, and storing the motion trajectory and the first focus and zoom parameters in a server for a control module to invoke;
a first control step: sending, by a host machine, a robotic arm control instruction generated based on the motion trajectory of the robotic arm to the control module, controlling, by the control module, the robotic arm to move according to the motion trajectory;
a dynamic pre-adjustment step: receiving, by the control module, position information of the robotic arm in real time, and obtaining target focus and zoom parameters corresponding to a current position of the robotic arm;
a second control step: generating, by the control module, a focus and zoom instruction based on the target focus and zoom parameters obtained in the dynamic pre-adjustment step, and sending the focus and zoom instruction to a shooting device; and
an image acquisition step: dynamically adjusting a focus position and a zoom magnification of a lens, by the shooting device, based on the first focus and zoom parameters according to the focus and zoom instruction to perform image acquisition.

9. The robotic arm shooting control method according to claim 8, wherein the dynamic pre-adjustment step comprises:
receiving, by the control module, the position information of the robotic arm in real time, and when a current position of the robotic arm is located on one of the motion nodes, selecting the first focus and zoom parameters corresponding to the one of the motion nodes, and when the current position of the robotic arm is located between two adjacent motion nodes, calculating second focus and zoom parameters corresponding to the current position via an interpolation algorithm;
wherein the second focus and zoom parameters are between the first focus and zoom parameters of the two adjacent motion nodes;
wherein the second control step comprises generating, by the control module, a focus and zoom instruction based on the first focus and zoom parameters or the focus and zoom parameters obtained from the dynamic pre-adjustment step, and sending the focus and zoom instruction to the shooting device.

10. The robotic arm shooting control method according to claim 9, wherein in the dynamic pre-adjustment step, when the robotic arm performs a linear motion between the two adjacent motion nodes, the interpolation algorithm adopts a linear interpolation method to calculate a focus parameter corresponding to the current position and a zoom parameter corresponding to the current position, and dynamically adjusts the second focus and zoom parameters corresponding to the current position of the shooting device;
when the robotic arm performs a non-linear motion between the two adjacent motion nodes, the interpolation algorithm adopts a distance-measurement interpolation method, comprising following steps:
dividing a path between the two adjacent motion nodes into n division points according to a motion trajectory distance of the robotic arm;
for each of the division points, calculating a distance x between each of the division points and the shooting target;
calculating a current focus parameter v=f(x) based on each distance x and a preset distance-to-focus relationship function f(x);
calculating a current zoom parameter based on each distance x and a preset distance-to-zoom relationship function g(x); and
dynamically adjusting the second focus and zoom parameters v and g(x) of the shooting device.

11. The robotic arm shooting control method according to claim 8, wherein the control module comprises a user interface for a user to input the first focus and zoom parameters, preview a shooting screen in real time, and perform parameter adjustment during a shooting process;
wherein after the image acquisition step, the robotic arm shooting control method further comprises:
a first real-time feedback fine-tuning step: receiving in real time, by the control module, a real-time distance between the current position of the robotic arm and the shooting target fed back by a distance detecting device installed on the robotic arm; when a discrepancy is found between real-time distance data and a preset distance corresponding to the target focus and zoom parameters obtained in the dynamic pre-adjustment step, fine-tuning, by the control module, the target focus and zoom parameters of the shooting device according to the real-time distance data; and
a second real-time feedback fine-tuning step: during a continuous motion of the robotic arm, an AI distance measurement module periodically acquires images from the shooting device, and performs preprocessing and feature extraction on the images; calculating the real-time distance between the shooting target and the shooting device based on image features and camera parameters of the shooting device; comparing, by the control module, the real-time distance with the preset distance corresponding to the target focus and zoom parameters obtained in the dynamic pre-adjustment step, and when the discrepancy is found, fine-tuning the target focus and zoom parameters of the shooting device;
wherein the AI distance measurement module comprises an image acquisition unit, an image preprocessing unit, a feature extraction unit, a distance calculation unit,
wherein the image acquisition unit is configured to periodically acquire the images of the shooting target during the motion of the robotic arm, the image preprocessing unit is configured to perform denoising and enhancement processing on the images, the feature extraction unit is configured to extract at least one of an edge feature, a shape feature, and a color feature of the shooting target from preprocessed images; and the distance calculation unit is configured to calculate the real-time distance between the shooting target and the shooting device based on a size of the shooting target, position information in the preprocessed image, a focal length and a sensor size of the camera, and at least one of the edge feature, the shape feature, and the color feature of the shooting target.

12. A computer-readable storage medium, comprising:
a computer program stored thereon, wherein when the computer program is executed, the robotic arm shooting control method according to claim 8 is performed.
